(19) United States
(12) Patent Application Publication
(10) Pub. No.: US 2020/0184862 A1
(43) Pub. Date: Jun. 11, 2020

(54) DIGITAL SIGNAGE AND CONTROL METHOD THEREFOR

(71) Applicant: LG ELECTRONICS INC., Seoul (KR)

(72) Inventors: JIHOON KIM, Seoul (KR); ILYONG LEE, Seoul (KR); SANGKI KIM, Seoul (KR); HEEJOO YOON, Seoul (KR)

(73) Assignee: LG ELECTRONICS INC., Seoul (KR)

(21) Appl. No.: 16/487,341

(22) PCT Filed: Mar. 22, 2017
(86) PCT No.: PCT/KR2017/003058

§ 371 Date: Aug. 20, 2019

(30) Foreign Application Priority Data
Feb. 21, 2017 (KR) 10-2017-0023127
Feb. 21, 2017 (KR) 10-2017-0023128

(51) Int. Cl. G09F 19/22; G09F 9/35; G06Q 30/02

(52) U.S. Cl. CPC G09F 19/22; G06Q 30/0246; G09F 9/35

(57) ABSTRACT

The present invention relates to digital signage comprising a large display part for outputting visual information. The digital signature comprises: a display part extending in one direction and formed in a bar shape; a sensing part, which is positioned in a region adjacent to the display part and detects at least one group; and a control part for dividing the display part into a plurality of regions such that the regions of the display parts are assigned to each of the at least one group, and controlling the display part such that visual information related to the at least one group is outputted to the region adjacent to the at least one group among the plurality of regions, wherein the control part divides the display part such that the region adjacent to the at least one group has a width corresponding to the width of the space occupied by the at least one group.

### TECHNICAL FIELD

The present invention relates to digital signage comprising a large display unit for outputting visual information and a control method therefor.

### BACKGROUND ART

Terminals may be divided into mobile/portable terminals and stationary terminals according to mobility. Also, the mobile terminals may be classified into handheld types and vehicle mount types according to whether or not a user can directly carry.

Mobile terminals have become increasingly more functional. Examples of such functions include data and voice communications, capturing images and video via a camera, recording audio, playing music files via a speaker system, and displaying images and video on a display unit. Some mobile terminals include additional functionality which supports electronic game playing, while other terminals are configured as multimedia players. Specifically, in recent time, mobile terminals can receive broadcast and multicast signals to allow viewing of video or television programs.

As it becomes multifunctional, a mobile terminal can be allowed to capture still images or moving images, play music or video files, play games, receive broadcast and the like, so as to be implemented as an integrated multimedia player.

Efforts are ongoing to support and increase the functionality of mobile terminals. Such efforts include software and hardware improvements, as well as changes and improvements in the structural components.

The recent trend towards larger display units and slimmer bezels has led to the development of technologies that provide outdoor advertising services by means of display devices. Such display devices are called digital signage.

Digital signage is a communication tool that allows corporates to create marketing advertisements and delivers customer experiences. The digital signage can be installed in various places, such as airports, hotels, stations, etc., and provides, through a large screen, various information related to the location of the digital signage, such as broadcast content, advertisements, transport schedules, match schedules, etc.

Recent digital signage has begun providing advertising information in such a manner as to allow for communications with the users viewing the advertising information, as well as providing one-way advertising information. As part of this development, digital signage technologies are being developed to provide customized information using user information.

Meanwhile, digital signage installed in places such as moving walkways, where the users' locations change in real time, have the problem of how to provide customized information.

### DISCLOSURE

### Technical Problem

Therefore, an object of the present invention is to provide a method that, when a plurality of users is viewing digital signage, allows a person whom a primary user of the digital signage is with to make use of the digital signage.

Another object of the present invention is to deliver new user experience to that person who is viewing digital signage.

Still another object of the present invention is to effectively provide user-customized information to a user who is on a moving means such as a moving walkway, through digital signage installed next to the digital signage.

### Technical Solution

Digital signage according to the present invention includes a display unit that displays first visual information, a camera that captures an image of the vicinity of the display unit, and a controller that, when a plurality of users is included in the captured image, classifies the plurality of users as a primary user of the first visual information and a sub-user whom the primary user is with, based on a preset condition, and that, when there is second visual information based on user information of the sub-user, outputs a graphics object representing the presence of the second visual information different from the first visual information on the display unit.

In one embodiment, the controller distinguishes between users viewing the display unit and users not viewing the display unit, based on movement information of the plurality of users included in the captured image, and classifies the users viewing the display unit into primary users and sub-users based on a preset condition.

In one embodiment, the preset condition is at least one of a condition related to each user's movement, a condition related to the centers of each user and display unit and the distance between each user, whether each user is of an age group or sex suitable for the type of visual information.

In one embodiment, the controller, when a user classified as the sub-user, among the plurality of users, is in plurality, selects a particular sub-user to be provided with the second visual information, from among the plurality of sub-users based on user information of the plurality of sub-users.

In one embodiment, the user information includes at least one among the user' age group and sex, and accessories worn on the user.

In one embodiment, the controller calculates the sub-user's interest level based on at least one among the sub-user's movement information, the sub-user's speech information, and the sub-user's gaze information, and outputs a graphics object representing the presence of the second visual information when the sub-user's interest level is a preset level or higher.

In one embodiment, the sub-user's movement includes an act of getting closer to the display unit and an act of getting closer to the primary user.

In one embodiment, the controller displays the first visual information and the second visual information together on the display unit when the graphics object is selected.

In one embodiment, the controller determines the output sizes of the first visual information and the second visual information based on the distance between the primary user and the display unit and the distance between the sub-user and the display unit.

In one embodiment, the controller determines the output sizes of the first visual information and the second visual information based on a touch pattern of touch inputs applied to the display unit.

In one embodiment, the controller controls the second visual information to disappear from the display unit when no control command related to the second visual information is not received for a preset period of time or the sub-user is not detected.

Digital signage according to the present invention includes a display unit that extends in one direction and is formed in a bar shape, a sensing unit that detects at least one group located in the vicinity of the display unit, and a controller that divides the display unit into a plurality of regions to allocate the regions of the display unit respectively to the at least one group and that controls the display unit so as to output visual information related to the at least one group to a region of the plurality of regions, the region being adjacent to the at least one group. The controller divides the display unit in such a way that the width of a region adjacent to the at least one group corresponds to the width of a space occupied by the at least one group.

In one embodiment, the at least one group consists of one or more group members and transportation bodies, and the space occupied by the at least one group is determined with respect to a group member and transportation body on the outermost edge, among all the group members and transportation bodies included in each group.

In one embodiment, the controller divides the display unit into the plurality of regions so that the center of the region adjacent to the at least one group coincides with the center for the group members in each of the at least one group when the display unit is capable of receiving touch inputs, and, the controller divides the display unit into the plurality of regions so that the center of the region adjacent to the at least one group coincides with the center of the space occupied by the at least one group when the display unit is not capable of receiving touch inputs.

In one embodiment, the controller classifies the group members as a particular group when a distance between the group members is a reference distance or shorter.

In one embodiment, the controller classifies the group members as a group when a number of group members with a reference distance or less therebetween is a predetermined number or less, and the controller classifies the group members as a non-group when the number of group members with the reference distance or less therebetween exceeds the predetermined number.

In one embodiment, the controller classifies the group members as group members of a particular group when a moving speed of the group members is a reference speed or lower.

In one embodiment, the display unit includes a start region and an end region located at opposite ends and a middle region between the start region and the end region, and the controller divides the middle region into a plurality of sub-regions based on group information of the at least one group.

In one embodiment, the controller outputs notification information notifying the end region on top of visual information related to a particular group so as to indicate that the user is in the end region when the particular group among the at least one group is located adjacent to the end region.

In one embodiment, the controller finishes outputting the visual information related to a particular group when a region allocated to the particular group among the at least one group at least partially overlaps the end region.

In one embodiment, the group information related to the at least one group contains information about group members of each group and information about items in a transportation body belonging to each group.

In one embodiment, the controller outputs preset basic information when the area of a region not adjacent to the at least one group, among the plurality of regions, is a preset area or larger, and the controller outputs a background image when the area of a region not adjacent to the at least one group is smaller than the preset area.

In one embodiment, the controller also changes the width of a particular region allocated to a particular group upon detecting a change in the number of group members in the particular group among the at least one group.

In one embodiment, the at least one group includes a first group and a second group. The controller allocates a first region to the first group, and a second region to the second group. The controller finishes outputting either visual information related to the first group displayed on the first region or visual information related to the second group displayed on the second region when detecting that the first region and the second region are at least partially overlapped with each other.

In one embodiment, the controller deallocates the first region from the first group when the moving speed of the first group is a reference speed or higher.

### Advantageous Effect

The above-described digital signage of the present invention is capable of providing visual information to a sub-user whom a primary user is with by dividing a display unit, while the primary user is using the digital signage. This way, the present invention allows for effectively providing relevant information to a sub-user whom a primary user is with, as well as to the primary user who is actively using the digital signage.

Furthermore, the present invention allows for effectively providing new information to a sub-user, while ensuring the usability of a primary user of the digital signage, by providing visual information related to the sub-user at an appropriate timing.

Furthermore, the present invention allows for delivering a new user experience by providing visual information related to a sub-user whom a primary user is with.

Furthermore, the digital signage according to the present invention provides customized information for each of a plurality of groups and ensures the usability of each individual group, by dividing a display unit into a plurality of regions according to the locations of groups present in the vicinity of the display unit, allocating a region of the plurality of regions, the region being adjacent to the groups to the groups, and providing information related to the groups.

Furthermore, the present invention allows for providing more convenient usability to every group member using group information by setting the areas of different regions allocated to different groups based on each group's group information.

### BRIEF DESCRIPTION OF THE DRAWINGS

FIG. 1A is a block diagram for explaining digital signage related to the present invention.

FIG. 1B is a perspective view of digital signage related to the present invention as viewed from one side.

FIG. 2 is a flowchart explaining a method of outputting visual information to a plurality of users by using digital signage related to the present invention.

FIGS. 3A and 3B are conceptual diagrams for explaining the flowchart of FIG. 2.

FIGS. 4A to 4D are conceptual diagrams showing a method of classifying primary users and sub-users.

FIGS. 5A and 5B are views showing a method of selecting a particular sub-user upon detecting a plurality of sub-users.

FIGS. 6A to 6C are conceptual diagrams showing an embodiment about the output timing of second visual information relative to a sub-user's interest level.

FIGS. 7A to 7C are conceptual diagrams showing how the output position of second visual information is determined according to a sub-user's location.

FIGS. 8A and 8B are conceptual diagrams explaining a method of setting the output size of visual information on a sub-user.

FIG. 9 is a conceptual diagram showing how digital signage related to the present invention is installed near a transportation device.

FIG. 10 is a conceptual diagram showing how visual information is displayed on a display unit of digital signage related to the present invention.

FIG. 11 is a flowchart explaining a method of allocating the display unit by group in digital signage related to the present invention.

FIGS. 12A and 12B are conceptual diagrams for explaining the control method of FIG. 11 in digital signage related to the present invention.

FIGS. 13A to 13C are conceptual diagrams showing an embodiment in which, if the number of group members of a particular group is changed, the size and location of a region allocated to the particular group are changed.

FIGS. 14A and 14B are conceptual diagrams showing how a region is allocated for each group if the locations of two groups are changed when different regions are respectively allocated to different groups.

FIGS. 15A and 15B are conceptual diagrams showing a control method digital signage installed near a start point and an end point of a moving walkway.

FIGS. 16A and 16B are conceptual diagrams showing a method of outputting preset visual information in an output region of the display unit 151 not allocated to a particular group.

FIG. 17 shows conceptual diagrams of a method of delivering visual information provided through digital signage to an external device.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

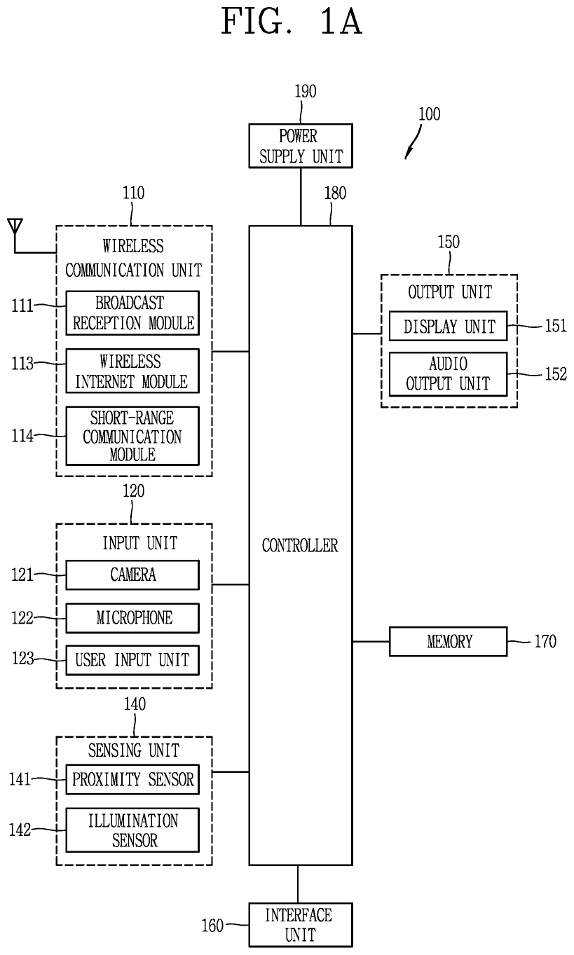

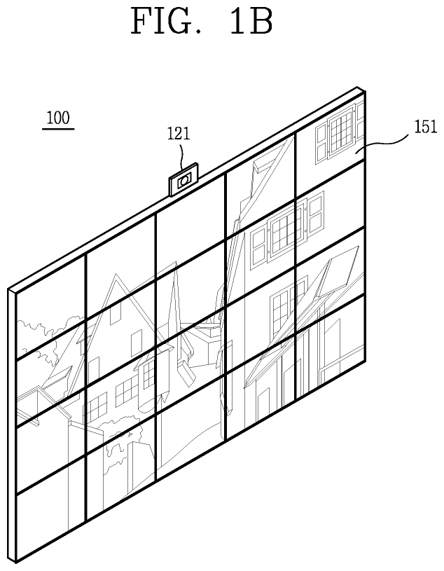

Referring to FIG. 1, FIG. 1 is a block diagram of digital signage in accordance with the present invention.

The digital signage 100 may be shown having components such as a wireless communication unit 110, an input unit 120, a sensing unit 140, an output unit 150, an interface unit 160, a memory 170, a controller (or control unit) 180, and a power supply unit 190. It is understood that implementing all of the illustrated components is not a requirement. Greater or fewer components may alternatively be implemented.

In more detail, the wireless communication unit 110 may typically include one or more modules which permit communications such as wireless communications between the digital signage 100 and a wireless communication system, communications between the digital signage 100 and another digital signage, or communications between the digital signage 100 and an external server. Further, the wireless communication unit 110 may typically include one or more modules which connect the digital signage 100 to one or more networks.

The wireless communication unit 110 may include one or more of a broadcast receiving module 111, a mobile communication module 112, a wireless Internet module 113, and a short-range communication module 114.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the digital signage, the surrounding environment of the digital signage, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The digital signage disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, and an audio output module 152. The display unit 151 may have an inter-layered structure or an integrated structure with a touch sensor in order to implement a touch screen. The touch screen may function as the user input unit 123 which provides an input interface between the digital signage 100 and the user and simultaneously provide an output interface between the digital signage 100 and a user.

The interface unit 160 serves as an interface with various types of external devices that are coupled to the digital signage 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the digital signage 100 may perform assorted control functions associated with a connected external device, in response to the external device being connected to the interface unit 160.

The memory 170 is typically implemented to store data to support various functions or features of the digital signage 100. For instance, the memory 170 may be configured to store application programs executed in the digital signage 100, data or instructions for operations of the digital signage 100, and the like. Some of these application programs may be downloaded from an external server via wireless communication. Other application programs may be installed within the digital signage 100 at the time of manufacturing or shipping, which is typically the case for basic functions of the digital signage 100 (for example, receiving a call, placing a call, receiving a message, sending a message, and the like). Application programs may be stored in the memory 170, installed in the digital signage 100, and executed by the controller 180 to perform an operation (or function) for the digital signage 100.

The controller 180 typically functions to control an overall operation of the digital signage 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1, to execute an application program that have been stored in the memory 170. In addition, the controller 180 may control at least two of those components included in the digital signage 100 to activate the application program.

The power supply unit 190 may be configured to receive external power or provide internal power in order to supply appropriate power required for operating elements and components included in the digital signage 100. The power supply unit 190 may include a battery, and the battery may be configured to be embedded in the terminal body, or configured to be detachable from the terminal body.

At least part of the components may cooperatively operate to implement an operation, a control or a control method of a digital signage according to various embodiments disclosed herein. Also, the operation, the control or the control method of the digital signage may be implemented on the digital signage by an activation of at least one application program stored in the memory 170.

Hereinafter, description will be given in more detail of the aforementioned components with reference to FIG. 1, prior to describing various embodiments implemented through the digital signage 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The wireless Internet module 113 refers to a module for wireless Internet access. This module may be internally or externally coupled to the digital signage 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the digital signage 100 and a wireless communication system, communications between the digital signage 100 and another digital signage 100, or communications between the digital signage and a network where another digital signage 100 (or an external server) is located, via wireless area networks. One example of the wireless area networks is a wireless personal area networks.

Here, another digital signage (which may be configured similarly to digital signage 100) may be a wearable device, for example, a smart watch, a smart glass or a head mounted display (HMD), which is able to exchange data with the digital signage 100 (or otherwise cooperate with the digital signage 100). The short-range communication module 114 may sense or recognize the digital signage, and permit communication between the wearable device and the digital signage 100. In addition, when the sensed digital signage is a device which is authenticated to communicate with the electronic device 100, the controller 180, for example, may cause transmission of at least part of data processed in the digital signage 100 to the digital signage via the short-range communication module 114. Hence, a user of the digital signage may use the data processed in the mobile terminal 100 on the digital signage. For example, when a call is received in the digital signage 100, the user may answer the call using the digital signage. Also, when a message is received in the digital signage 100, the user can check the received message using the digital signage.

Next, the input unit 120 is configured to permit various types of inputs to the digital signage 100. Examples of such inputs include image information (or signal), audio information (or signal), data or various information input by a user, and may be provided with one or a plurality of cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the digital signage 100, and a plurality of image information having various angles or focal points may be input in the digital signage 100 through the cameras 121 having the matrix configuration. Also, the cameras 121 may be located in a stereoscopic arrangement to acquire left and right images for implementing a stereoscopic image.

The microphone 122 processes an external audio signal into electric audio (sound) data. The processed audio data may be processed in various manners according to a function (or application program) being executed in the digital signage 100. If desired, the microphone 122 may include assorted noise removing algorithms to remove unwanted noise generated in the course of receiving the external audio signal.

The user input unit 123 is a component that permits input by a user. Such user input may enable the controller 180 to control an operation of the digital signage 100 to correspond to input information. The user input unit 123 may include one or more of a mechanical input element (for example, a mechanical key, a button located on a front and/or rear surface or a side surface of the digital signage 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the digital signage, surrounding environment information of the digital signage, user information, or the like, and generate a corresponding sensing signal. The controller 180 generally cooperates with the sending unit 140 to control operations of the digital signage 100 or execute data processing, a function or an operation associated with an application program installed in the digital signage 100 based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the digital signage covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 may control the digital signage 100 to execute different operations or process different data (or information) according to whether a touch with respect to a point on the touch screen is either a proximity touch or a contact touch.

A touch sensor can sense a touch (or a touch input) applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

In such a manner, when there is a touch input on the touch sensor, signal(s) corresponding thereto are sent to a touch controller. The touch controller processes the signal(s) and then transmits corresponding data to the controller 180. Therefore, the controller 180 may recognize which region of the display unit 151 is touched. Herein, the touch controller may be a separate component from the controller 180, or may be the controller 180 itself.

Meanwhile, the controller 180 may perform different controls or the same control according to the types of a touch target touching the touch screen (or a touch key provided in addition to the touch screen). Whether to perform different controls or the same control according to the types of a touch target may be determined according to the current operating state of the digital signage 100 or an application program being executed.

Meanwhile, the above-mentioned touch sensor and proximity sensor are provided separately or in combination, and may thus sense various types of touches, for example, short (or tap) touch, long touch, multi-touch, drag touch, flick touch, pinch-in touch, pinch-out touch, swipe touch, and hovering touch for the touch screen.

The ultrasonic sensor may recognize position information of a detection target by using ultrasonic waves. Moreover, the controller 180 may calculate the position of a wave source through information detected by an optical sensor and a plurality of ultrasonic sensors. The position of the wave source may be calculated by using the property that light is much faster than ultrasonic wave, that is, the time taken for light to reach an optical sensor is much shorter than the time taken for an ultrasonic wave to reach an ultrasonic sensor. In more detail, the position of the wave source may be calculated based on the time difference with the time taken for an ultrasonic wave to reach by using light as a reference signal.

Moreover, the camera 121 described as a configuration of the input unit 120 may include at least one among a camera sensor (for example, CCD and CMOS), a photo sensor (or an image sensor), and a laser sensor.

The camera 121 and the laser sensor may be combined to detect a touch of a detection target for a three-dimensional image. The photo sensor may be stacked on a display element and is configured to scan the movement of a detection target close to the touch screen. In more detail, the photo sensor is equipped with photo diodes and transistors (TR) in a row/column, and scans content placed on the photo sensor by using an electrical signal which changes with the amount of light applied to the photo diodes. That is, the photo sensor may calculate the coordinates of a detection target according to the amount of change in light and through this, may obtain the position information of the detection target.

The display unit 151 may display (output) information processed in the digital signage 100. For example, the display unit 151 may display execution screen information of an application program running on the digital signage 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output unit 152 may receive audio data from the wireless communication unit 110 or output audio data stored in the memory 170 during modes such as a signal reception mode, a call mode, a record mode, a voice recognition mode, a broadcast reception mode, and the like. The audio output unit 152 may output audio signals related to a function (e.g., a call signal reception sound, a message reception sound, etc.) performed by the digital signage 100. The audio output unit 152 may also be implemented as a receiver, a speaker, a buzzer, or the like.

The interface unit 160 serves as an interface for external devices to be connected with the digital signage 100. For example, the interface unit 160 can receive data transmitted from an external device, receive power to transfer to elements and components within the digital signage 100, or transmit internal data of the digital signage 100 to such external devices. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information to authenticate the use of the digital signage 100, and may include a user identity module (UIM), a subscriber identity module (SIM), a universal subscriber identity module (USIM), etc. A device (hereinafter, identification device) with an identity module may be made in the form of a smart card. Thus, the identification device may be connected to the digital signage 100 via the interface unit 160.

The interface unit 160 may serve as a passage through which electric power from an external cradle is supplied to the digital signage 100 when the digital signage 100 is connected to the cradle, or serve as a passage through which various command signals input from the cradle by the user are sent to the digital signage 100. The various command signals or power input from the cradle may operate as signals for detecting that the digital signage 100 has been mounted correctly at the cradle.

The memory 170 can store programs to support operations of the controller 180 and store input/output data (for example, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The digital signage 100 may also be operated in relation to a web storage that performs the storage function of the memory 170 over the internet.

As described above, the controller 180 can control operations relating to application programs—typically, the overall operations of the digital signage 100. For example, the controller 180 can set or release a lock state for restricting a user from inputting a control command with respect to applications when a status of the digital signage meets a preset condition.

The controller 180 can also perform controlling and processing associated with voice calls, data communications, video calls, and the like, or perform pattern recognition processing to recognize a handwriting input or a picture drawing input performed on the touch screen as characters or images, respectively. In addition, the controller 180 can control one of the aforementioned components or a combination thereof, in order to implement various exemplary embodiments disclosed herein on the digital signage 100 according to the present invention.

The power supply unit 190 receives external power or internal power and supplies power required for the operations of the components under the control of the controller 180. The power supply unit 190 may include a battery. The battery is a rechargeable built-in battery, and may be detachably coupled to a terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without using the connection port. In this example, the power supply unit 190 can receive power, transferred from an external wireless power transmitter, using at least either or both of an inductive coupling method based on magnetic induction or a magnetic resonance coupling method based on electromagnetic resonance.

Various embodiments described herein may be implemented in a computer-readable medium, a machine-readable medium, or similar medium using, for example, software, hardware, or any combination thereof.

Below is a description of a perspective view of the digital signage 100 comprising at least one of the components explained with reference to FIG. 1A.

Referring to FIG. 1B, the digital signage 100 may have a display unit on the front of a main body.

The display unit 151 may be a plurality of display units that are combined together to output a single image, or a single display unit that forms a large screen.

In the case of a plurality of display units that are combined together to output a single image, the bezel of each display unit may be very thin. It gives the user an experience as if the plurality of display units output a single image.

The plurality of display units 151, if combined together, may take various shapes. For example, as shown in FIG. 1B, the plurality of display units 151 altogether may form a single rectangular shape. Besides, the display units 151 may have various shapes including a blind, a door, a curve, etc., depending on their properties or the shape of a surface where the display units 151 are installed.

The display unit 151 may be both-sided. That is, the display unit 151 may be formed such that visual information is displayed on both the front and rear. Thus, the user may get visual information, regardless of whether the user is at the front or rear.

Moreover, the display unit 151 may be transparent. Thus, the user is able to see the outside environment and visual information at the same time through the display unit 151.

Referring to FIG. 1B, a camera 121 configured to capture an image may be provided on the front of the digital signage 100. The camera 121 may be configured to capture images in front of the digital signage 100. The camera 121 may capture an image of the user viewing the digital signage 100 or an image of an object close to the digital signage 100.

Meanwhile, although not shown, the camera 121 may be positioned on the rear or side of the digital signage 100 to capture the rear or side of the digital signage 100, as well as the front thereof.

The foregoing description has been given of an embodiment of the digital signage 100.

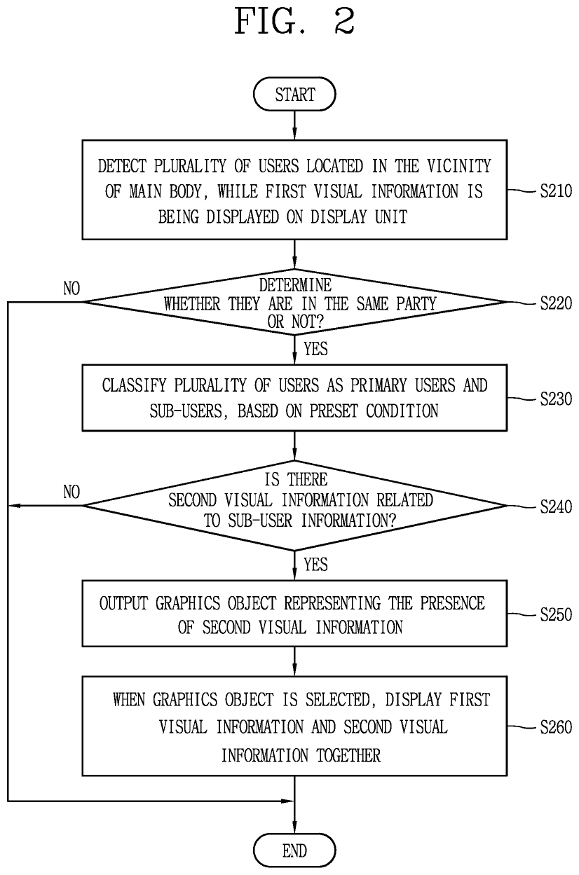

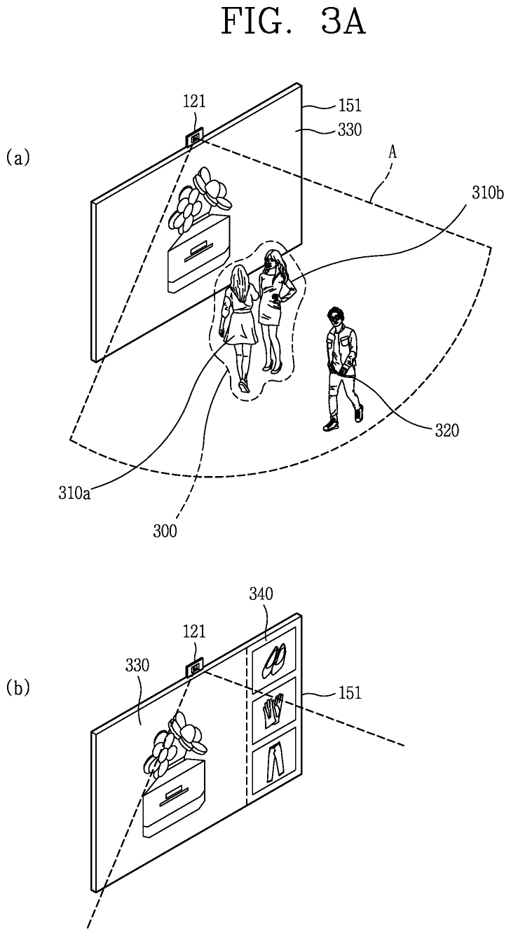

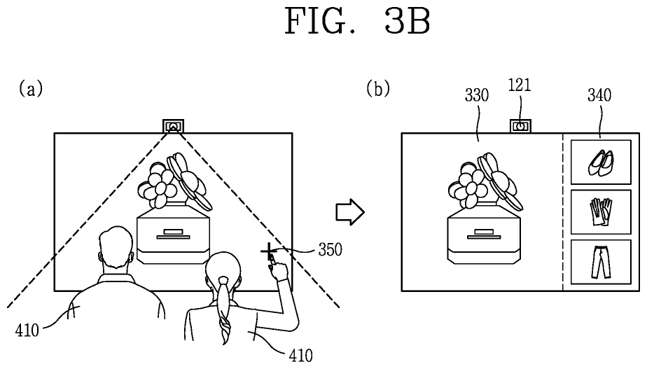

Below is a description of a method of providing visual information to a plurality of users of the digital signage 100. FIG. 2 is a flowchart explaining a method of outputting visual information to a plurality of users by using digital signage related to the present invention. FIGS. 3A and 3B are conceptual diagrams for explaining the flowchart of FIG. 2.

First of all, referring to FIG. 2, the controller of the digital signage according to the present invention may detect a plurality of users located in the vicinity of the display unit 151, while first visual information is being displayed on the display unit 151 (S210).

Referring to (a) of FIG. 3A, the digital signage 100 may capture the vicinity A of the display unit 151 through the camera 121. Here, the vicinity A is a region situated at the front of the display unit 151, which corresponds to the viewing angle range of the camera 121.

The controller 180 may capture an image of the vicinity A through the camera 121, analyze the captured image through image analysis, and detect users present in the vicinity A. For example, as shown in (a) of FIG. 3A, the controller 180 may detect three people present in the vicinity A, through the image of the vicinity A.

Also, the controller 180 may distinguish between digital signage users and passers-by, among the people present in the vicinity A, based on the image of the vicinity A. Here, the users refer to persons 310a and 310b (see (a) of FIG. 3A) in the vicinity A who are viewing the digital signage without moving, and the passers-by simply refer to persons 320 (see (a) of FIG. 3A) who pass by the vicinity of the digital signage. That is, the users are persons who are looking with interest at the visual information on the digital signage and can interact with the digital signage, and the passers-by are persons who pass by the digital signage.

To distinguish between the users and the passers-by, the controller 180 may detect movements of the people included in the vicinity A. Specifically, if any one of the people located within the vicinity A stays in the vicinity A for a certain amount of time, the controller 180 detects him or her as a user, and, if that person moves out of the vicinity A within a certain amount of time, the controller 180 may detect him or her as a passer-by. Also, if the frontal face of any one of the people located within the vicinity A is detected for more than a certain amount of time, the controller 180 may detect him or her as a user, and, otherwise, the controller 180 may detect him or her as a passer-by. Besides, the controller 180 may distinguish between users and passers-by, based on various conditions.

If there are a plurality of users located within the vicinity A, the controller 180 may determine whether they are in the same party or not (S220). Here, the term “party” refers to an assemblage or aggregation of persons gathered or located together. In this specification, a party may be defined as a group of people who are viewing signage together.

The controller 180 may take into consideration at least one among relative distances between a plurality of users, age groups, and clothing, in order to determine whether the plurality of users is in the same party or not. For example, if the relative distances between the plurality of users is shorter than a reference distance, the controller 180 may consider them as being in the same party, and if the relative distances between the plurality of users is longer than the reference distance, the controller 180 may view them as not being in the same party. In another example, if the plurality of users' age groups is within a specific range, the controller 180 may consider them as being in the same group, and, otherwise, the controller 180 may consider them as not being in the same group.

Once the plurality of users is considered as being in the same party, the controller 180 may classify them as primary users and sub-users, based on preset condition (S230).

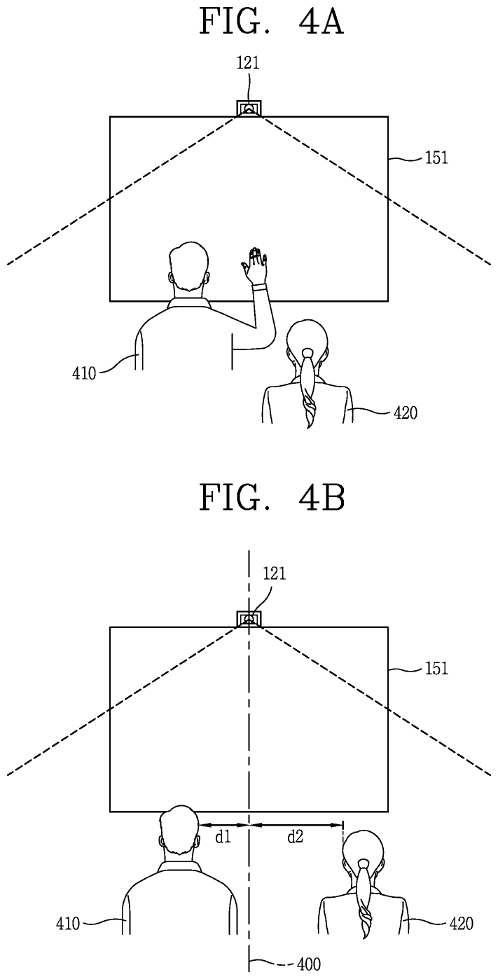

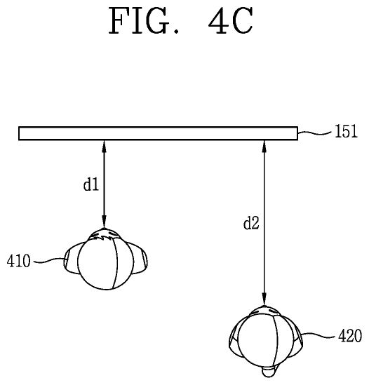

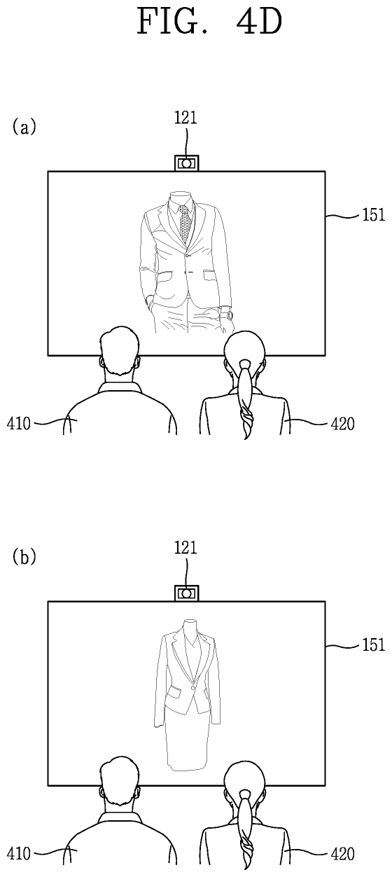

Based on the preset condition, the controller 180 may classify the plurality of users as a primary user who mostly makes use of the first visual information and a sub-user whom the primary user is with. The preset condition may be at least one of the following: whether a user is the first person who is attempting to touch the display unit 151, whether a user is the closest person to the center line of the display unit 151, whether a user is at the shortest distance from the display unit 151, and whether a user is a main target group of the first visual information. A concrete description of this will be given with reference to FIGS. 4A to 4D below.

After classifying the plurality of users as primary users and sub-users, the controller 180 may retrieve second visual information related to sub-user information (S240).

A plurality of visual information may be pre-stored in the memory 170 of the digital signage according to the present invention or in web storage connected to the digital signage via the internet. The plurality of visual information may include advertising information, video, images, event information, etc. The event information may be occasion information related to the building or location where the digital signage is located.

Based on the sub-user information, the controller 180 may retrieve second visual information from the plurality of visual information stored in the memory 170 or web storage.

The sub-user information may be at least one of the following: the sub-user' age group and sex, and accessories worn on the sub-user, and the sub-user' speech information.

For example, if the sub-user is a female, the second visual information may be information on women's wear on sale, cosmetic shop information, etc.

Also, the controller 180 may retrieve second visual information related to the sub-user information and also related to the first visual information. In another example, the first visual information is movie ticketing information and the sub-user is a female, the second visual information may be information on that female sub-user's favorite movies.

That is, the second visual information may be relevant information to be provided to the sub-user, while the first visual information the primary user is currently using is being displayed. Such user information may be acquired through an image analysis algorithm.

If there is second visual information, the controller 180 may output a graphics object representing the presence of the second visual information on the display unit (S250).

Upon detecting second visual information, the controller 180 may output a graphics object representing the presence of second visual information. Thus, the sub-user may recognize the presence of the second visual information.

The graphics object may be outputted to a region corresponding to the sub-user's location. For example, if the primary user is at the center of the display unit and the sub-user is to the right of the primary user, the controller 180 may output a graphics object to a region to the right of the center of the display unit.

For example, as shown in (a) of FIG. 3B, upon detecting a sub-user 420 at the right of a primary user 410, the controller 180 may output a graphics object 350 in a right region of the display unit 151. Therefore, the present invention enables the sub-user to naturally recognize the presence of the graphics object by outputting the graphics object 350 to where the sub-user's eyes go.

The graphics object may take the shape of a particular figure as shown in (a) of FIG. 3B or take the form of a summary of the second visual information. For example, the graphics object may contain a phrase like “Get 30% off a perm at OO shop”. Thus, the user may check out simple things related to the second visual information.

The output form of the graphics object may differ according to the second visual information. That is, the graphics object may take a unique output form for each second visual information. For example, if the second visual information is cosmetic public relations information, the graphics object may take the form of a cosmetic container, or if the second visual information is information on a particular movie, the graphics object may take the form of a movie poster.

Although not shown, the controller 180 may add an animated effect to the graphics object. The animated effect may include flashing, vibrating, and color-changing. For example, the controller 180 may control the graphics object so that the graphics object flashes.

Meanwhile, after classifying sub-users, if there is second visual information related to the sub-user information, among the plurality of visual information stored in the memory 170 or web storage, the controller 180 may output the graphics object. That is, if there is relevant visual information that fits the sub-user information, the controller 180 may output a graphics object immediately without calculating the sub-user's interest level.

If the graphics object representing the second visual information is selected, the controller 180 may output the first visual information and the second visual information together on the display unit (S260).

The controller 180 may output the second visual information on the display unit 151, based on a touch input on the graphics object. For example, as shown in (a) of FIG. 3B, the sub-user may apply a touch input on the graphics object. Hereupon, as shown in (b) of FIG. 3B, the controller 180 may output the second visual information 340 on the display unit 151.

The controller 180 may divide the display unit into a first region and a second region in order to output the second visual information. Afterwards, as shown in (b) of FIG. 3B, the controller 180 may display the first visual information 330 on the first region and the second visual information 340 on the second region. Meanwhile, although not shown, the controller 180 may set the number of regions by which the display unit 151 is divided, according to the number of sub-users. For example, if there are two sub-users, the controller 180 may divide the display unit 151 into a total of three regions.

The controller 180 may set a region corresponding to a sub-user's location as the second region so that the second visual information is displayed in the region corresponding to the sub-user's location. More specifically, the controller 180 may set a region adjacent to the sub-user's location as the second region. For example, as shown in (b) of FIG. 3B, if the sub-user is located in a right region of the display unit 151, the controller 180 may set this right region as the second region.

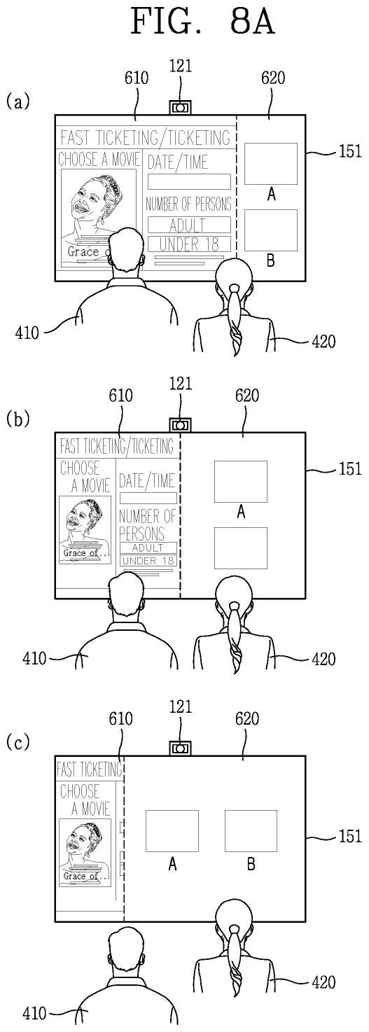

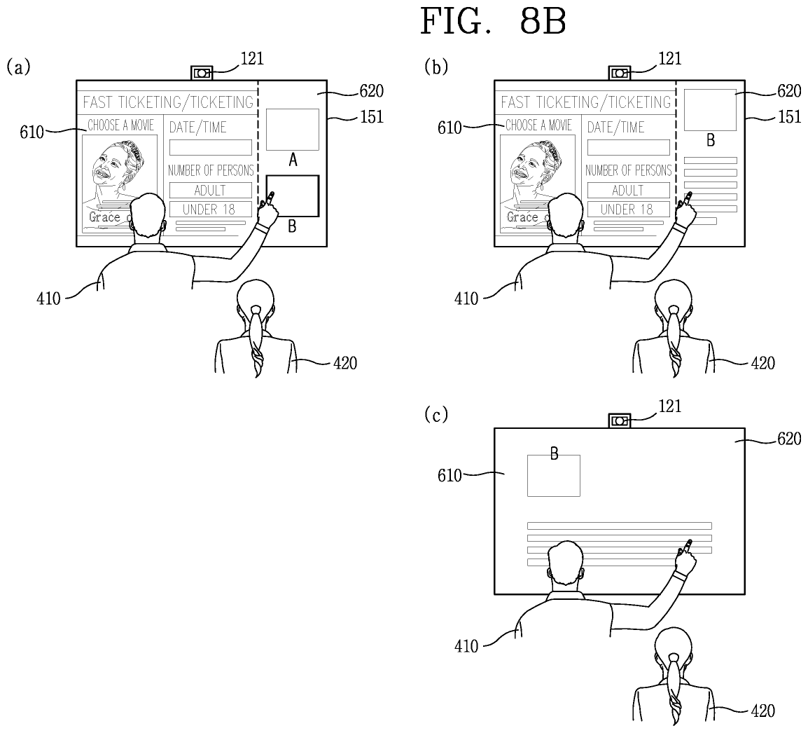

Meanwhile, the controller 180 may determine the sizes of the first and second regions, based on at least one between the distance between the sub-user and the display unit and the sub-user's movement information. For example, if the distance between the sub-user and the display unit is a first distance, the controller 180 may set the second region to a first size, or if the distance between the sub-user and the display unit is a second distance shorter than the first distance, the controller 180 may set the second region to a second size larger than the first size. In another example, if the sub-user applies a preset number of inputs or more related to the second visual information, the controller 180 may gradually increase the size of the second region. A detailed description about this will be given later with reference to FIGS. 8A and 8B.

When the second visual information is displayed, the controller 180 may change the output form of the first visual information already being displayed. For example, the controller 180 may decrease the output size of the first visual information or dim the output lighting. Therefore, the present invention allows the primary user and the sub-user to easily recognize the second visual information by highlighting the second visual information which is outputted later.

The controller 180 may control the first visual information and the second visual information individually. For example, upon a touch input on the first visual information, the controller 180 may execute a function related to the first visual information, in response to the touch input. In this case, the second visual information may be outputted in the same form, regardless of the touch input. Thus, the primary user and the sub-user are not disturbed in terms of usability, and may make use of the digital signage.

If the graphics object is not selected for a certain amount of time or the presence of a sub-user is not detected for a certain amount of time, the controller 180 may let the graphics object to disappear from the display unit 151.

The foregoing description has been given of a method of providing visual information to a sub-user of digital signage. This way, the present invention allows for effectively providing relevant information to a sub-user whom a primary user is with, as well as to the primary user who is actively using the digital signage.

Below is a description of a method of classifying primary users and sub-users. FIGS. 4A to 4D are conceptual diagrams showing a method of classifying primary users and sub-users.

Upon detecting a plurality of users viewing the digital signage 100, the controller 180 may classify the plurality of users as primary users and sub-users, based on preset condition.

The preset condition may be at least one of the following: whether a user is the first person who is attempting to touch the display unit 151, whether a user is the closest person to the center line of the display unit 151, whether a user is at the shortest distance from the display unit 151, and whether a user is a main target group of the first visual information.

More specifically, the controller 180 may set the first person who touches the display unit 151, among the plurality of users, as a primary user. That is, referring to FIG. 4A, the controller 180 may detect a first user 410 and a second user 420. In this instance, the controller 180 may detect that the first user 410 is touching the display unit 151 first. Hereupon, the controller 180 may classify the first user 410 as a primary user and the second user 420 as a sub-user.

Also, the controller 180 may classify primary users and sub-users according to the distance between each user and the center line 400 of the display unit 151. Referring to FIG. 4B, the controller 180 may set the first user 410 who is closer to the center line 400 as a primary user and the second user 420 who is farther away from the center line 400 as a sub-user.

Also, the controller 180 may classify primary users and sub-users based on the relative distance between the display unit 151 and each user. Referring to FIG. 4C, if the distance between the display unit 151 and the first user 410 is d1 and the distance between the display unit 151 and the second user 520 is d2, which is longer than d1, the controller 180 may set the first user 410 as a primary user and the second user 420 as a sub-user.

Also, the controller 180 may classify a user as a primary user if he or she is a main target group of the visual information displayed on the display unit 151. To this end, the controller 180 may detect the main target group based on the type of visual information and the age group and sex of the user. For example, referring to (a) of FIG. 4D, if a men's wear image is displayed on the display unit 151, the controller 180 may set the male user 410 as a primary user and the female user 420 as a sub-user. On the contrary, referring to (b) of FIG. 4D, if a women's wear image is displayed on the display unit 151, the controller 180 may set the female user 420 as a primary user and the male user 410 as a sub-user.

Meanwhile, the above-explained conditions are not applied singularly, but the controller 180 may classify primary users and sub-users based on at least two of these conditions. For example, upon detecting two female users while a women's wear image is displayed on the display unit 151, the controller 180 may set the female user closer to the display unit 151 as a primary user.

The foregoing description has been given of a method of classifying a plurality of users of digital signage as primary users and sub-users.

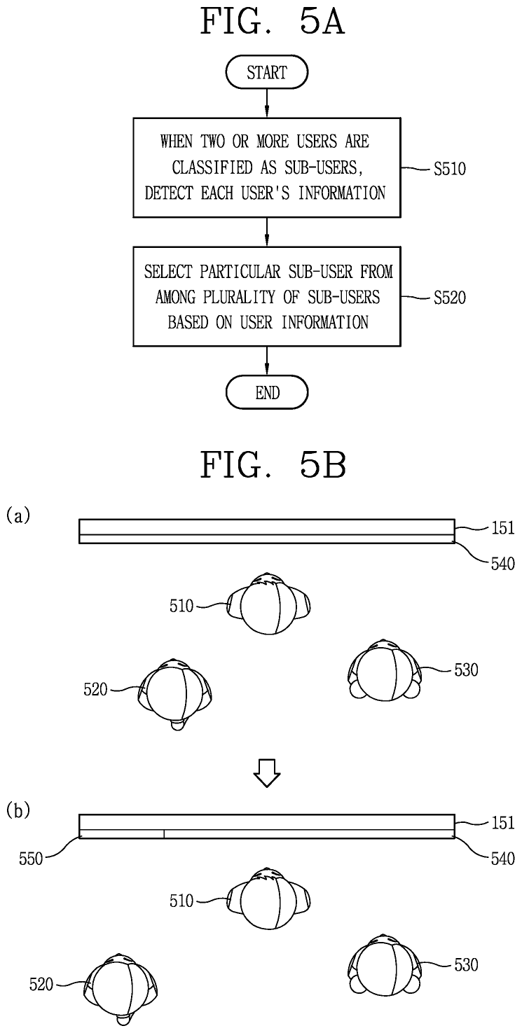

Below is a description of a method of selecting a particular sub-user when a plurality of users is classified as sub-users. FIGS. 5A and 5B are views showing a method of selecting a particular sub-user upon detecting a plurality of sub-users.

After classifying primary users and sub-users, if a plurality of persons is classified as the sub-users, the controller 180 may select a particular sub-user who will be provided with second visual information, from among the plurality of sub-users.

Referring to FIG. 5A, first of all, if two or more users are classified as sub-users, the controller 180 may detect each user's information (S510).

As shown in (a) of FIG. 5B, upon detecting one primary user 510 and a plurality of sub-users 520 and 530, the controller 180 may detect user information of each of the plurality of sub-users 520 and 530. To this end, the controller 180 may capture images of the plurality of sub-users through the camera 121 and analyze the captured images through an image analysis algorithm. The controller 180 may retrieve user information based on analysis results.

The user information may include the user' age group and sex, and accessories worn on the user.

Afterwards, the controller 180 may select a particular sub-user from among the plurality of sub-users based on the user information (S520).

The controller 180 may select a particular sub-user who fits a preset condition, from among the plurality of sub-users. The preset condition may be user information of a main target group who will be provided with second visual information.

The preset condition may be determined by the type of visual information the digital signage can provide. That is, the digital signage according to the present invention may store available visual information in advance and set a main target group for each stored visual information.

The controller 180 may compare the preset condition and the user information of each of the plurality of sub-users, and select a particular sub-user who most fits the preset condition and the user information based on comparison results.

For example, the preset condition may be a female in her 20's or 30's. In this case, the controller 180 may select a particular sub-user who is a female in her 20's or 30's.

Then, the controller 180 may provide second visual information to the selected particular sub-user. To this end, referring to (a) of FIG. 5B, the controller 180 may select a particular sub-user 520 from among the plurality of sub-users 520 and 530.

Also, the controller 180 may divide the display unit 151 based on the particular sub-user 520's location information, in order to provide second visual information to the particular sub-user 520. More specifically, the controller 180 may divide the display unit 151 such that second visual information is displayed in a region adjacent to the particular sub-user 520. That is, as shown in (b) of FIG. 5B, second visual information 550 may be displayed on the left side of the display unit 151, and first visual information 540 may be displayed on the right side thereof.

The foregoing description has been given of a method of providing visual information to a particular sub-user when there is a plurality of sub-users. However, the present invention is not limited to this, but all of the plurality of users may be provided with visual information. In this case, the display unit 151 may be divided based on each sub-user's location information, in order for the display unit 151 provides visual information to each region, and visual information may be provided to each sub-user.

The foregoing description has been given of a method of selecting a particular sub-user who will be provided with visual information when there is a plurality of sub-users. This way, the present invention prevents an increase in visual complexity which results from the simultaneous use of digital signage by a plurality of users.

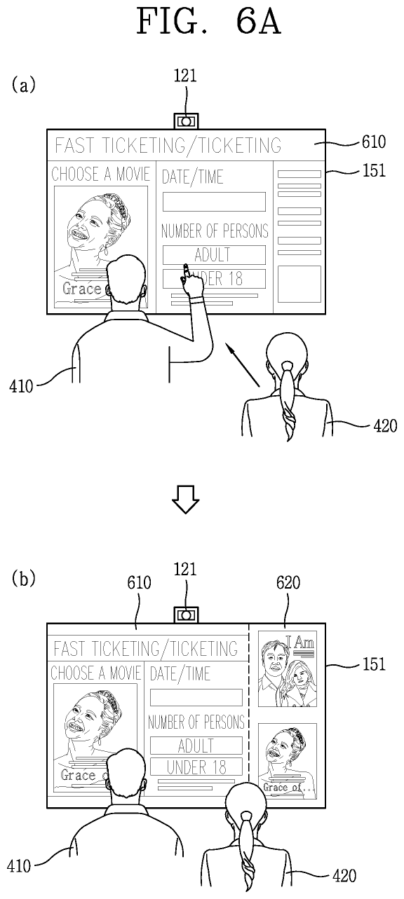

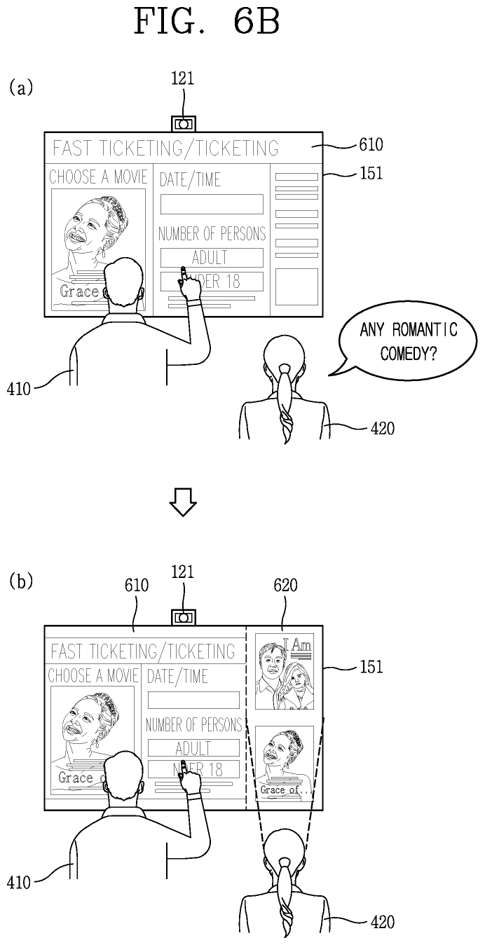

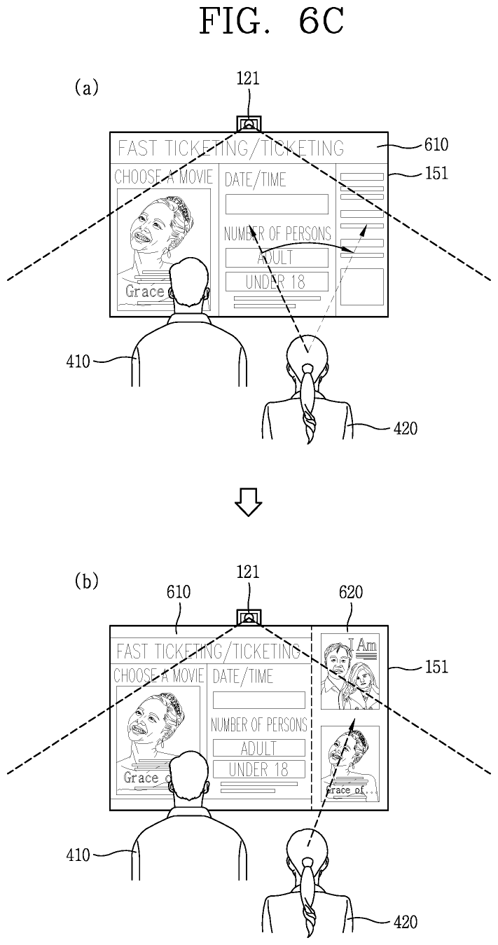

Below is a description of the output timing of second visual information relative to a sub-user's interest level. FIGS. 6A to 6C are conceptual diagrams showing an embodiment about the output timing of second visual information relative to a sub-user's interest level.

The controller 180 may measure a sub-user's interest level while first visual information is being displayed. The sub-user's interest level represents how interested the sub-user is in the information displayed on the digital signage.

Moreover, upon detecting that the sub-user's interest is a preset level or above, the controller 180 may provide second visual information related to the sub-user. Specifically, the controller 180 may output second visual information or a graphics object representing the presence of the second visual information at a timing when the sub-user's interest is a preset level or above.

The sub-user's interest may be considered low or high. Alternatively, the sub-user's interest may be numerically calculated (for example, as a value between 1 and 10). It is apparent to those skilled in the art that the design of interest level measurements may be changed.

For example, upon detecting a sub-user touching the digital signage or getting closer to a primary user, the controller 180 may change the sub-user's interest level from low to high. In another example, if the sub-user's speech information contains a request for information associated with the information currently displayed on the digital signage, the controller 180 may change the sub-user's interest level from low to high. In yet another example, if the sub-user's eyes stay on the digital signage for more than a preset amount of time, the controller 180 may change the sub-user's interest level from low to high.

The controller 180 may measure the sub-user's interest level based on various information related to the sub-user. The various information related to the sub-user may include at least one among the sub-user's movement information, the sub-user's speech information, and the sub-user's gaze information. The sub-user's movement information may include the sub-user's act of getting closer to the display unit 151, the sub-user's act of getting closer to the primary user, etc.

For example, as shown in (a) of FIG. 6A, the controller 180 may detect the sub-user 420's getting closer to the primary user while the primary user 410 is using the digital signage.

Upon detecting the sub-user 420's getting closer to the primary user, the controller 180 may determine that the sub-user's interest is a preset level or above. Also, as shown in (b) of FIG. 6A, the display unit 151 may be divided into two regions, and then first visual information 610 may be outputted to the first region and second visual information 620 may be outputted to the second region. The second region is a region adjacent to the sub-user's location.

In another example, the controller 180 may calculate the sub-user's interest level based on the sub-user's speech information.

As shown in (a) of FIG. 6B, the controller 180 may receive the sub-user 420's voice while the primary user 410 is using the digital signage. Also, the controller 180 may create speech information by analyzing the sub-user 420's voice.

The controller 180 may determine whether the sub-user 420 wants new information different from the first visual information currently being displayed, based on the speech information. For example, as shown in (a) of FIG. 6B, upon receiving speech information of a voice saying “Any romantic comedy?”, the controller 180 may determine that the sub-user 420 currently wants information about “romantic comedies”.

In this case, the controller 180 may change the sub-user 420's interest level from low to high. Also, the controller 180 may divide the display unit 151 in order to output second visual information.

Moreover, as shown in (b) of FIG. 6B, the second visual information 620 may be outputted to a region adjacent to the sub-user 420's location. The second visual information 620 is information related to the sub-user 420's speech information. Thus, the sub-user may be provided with visual information they want, without disturbing the primary user's use of the digital signage.

In another example, the controller 180 may calculate the sub-user's interest level based on the sub-user's gaze information. The controller 180 may create gaze information based on an image of the eyes included in a sub-user's image captured through the camera 121.

As shown in (a) of FIG. 6C, upon detecting the sub-user's shifting his or her gaze from the center of the display unit 151 to the edge, while the first visual information is being displayed on the display unit 151, the controller 180 may detect that the sub-user's interest in the first visual information has decreased. Along with this, the controller 180 may determine that the sub-user's interest in the second visual information has increased.

If the sub-user's interest is a preset level or above, the controller 180 may divide the display unit 151 in order to display the second visual information. In this case, the controller 180 may determine where to display the second visual information, based on the user's gaze information. For example, as shown in (b) of FIG. 6C, if the user is looking at a right region of the display unit 151, the controller 180 may divide the display unit 151 in order to display the second visual information in the right region.

While the foregoing description has been given of an example in which the interest level is measured under one condition, the interest level may be measured under two or more conditions.

If the sub-user's interest is a preset level or above, the controller 180 may retrieve second visual information pre-stored in the memory 170 or web storage.

The preset level may be a level of interest sufficient for the sub-user to change the visual information outputted on the digital signage. For example, the preset level may be a high level of interest or above. In another example, the preset level may be an interest level of 5 or above when the interest level ranges from 1 to 10.

The foregoing description has been given of a method of determining the output position of second visual information according to a sub-user's interest level. In the present invention, if a sub-user's interest increases while a primary user is viewing screen information, the sub-user may be provided with additional information without disturbing a primary user's use of digital signage. Thus, the present invention may deliver new user experience to both the primary user and the sub-user.

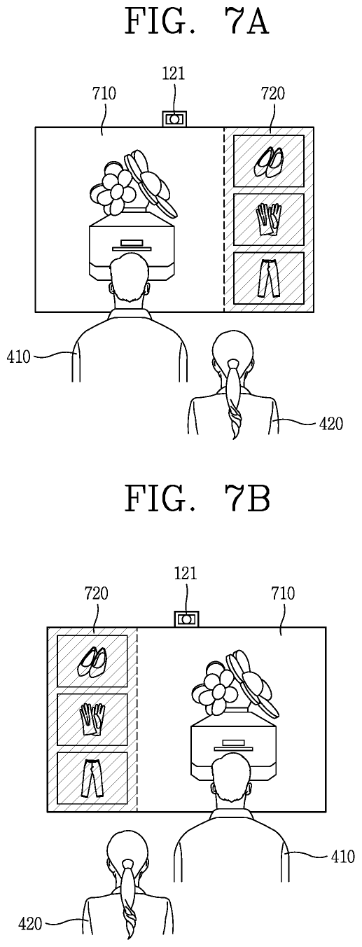

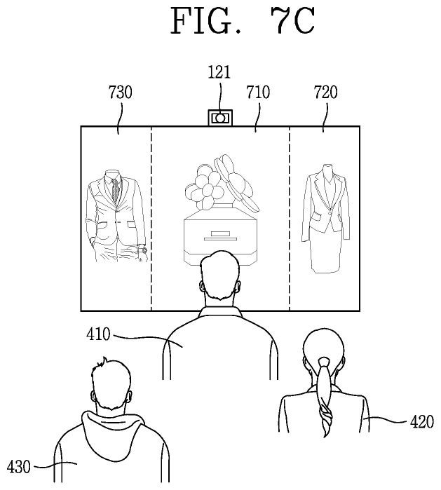

Below is a description of a method of determining the output position of second visual information according to a sub-user's location. FIGS. 7A to 7C are conceptual diagrams showing how the output position of second visual information is determined according to a sub-user's location.

The controller 180 may divide the display unit 151 in order to output second visual information. In this case, the controller 180 may divide the display unit 151 based on a sub-user's location information. That is, the controller 180 may divide the display unit 151 in such a way that second visual information is displayed in a region adjacent to the sub-user's location.

For example, as shown in FIG. 7A, if the sub-user 420 is located at the right side of the display unit 151, the controller 180 may divide the display unit 151 in such a manner that second visual information 720 is displayed in a right region of the display unit 151.

In another example, as shown in FIG. 7B, if the sub-user 420 is located at the left side of the display unit 151, the controller 180 may divide the display unit 151 in such a manner that second visual information 720 is displayed in a left region of the display unit 151.

Meanwhile, if there are two or more sub-users, the controller 180 may divide the display unit 151 so as to provide as many regions as the number of sub-users. For example, as shown in FIG. 7C, if there are a primary user 410, a first sub-user 420, and a second sub-user 430, the controller 180 may divide the display unit 151 so that visual information is displayed in regions adjacent to the first sub-user 420 and second sub-user 430.

Also, the controller 180 may output visual information 720 related to the first sub-user 420 and visual information 730 related to the second sub-user 430 on the display unit 151.

The digital signage according to the present invention may provide additional information to a sub-user while ensuring the usability of a primary user, by dividing the display unit in such a way that visual information related to the primary user and visual information related to the sub-user are provided.

Below is a description of a method of setting the output size of visual information on a sub-user. FIGS. 8A and 8B are conceptual diagrams explaining a method of setting the output size of visual information on a sub-user.

When displaying first visual information and second visual information together on the display unit 151, the controller 180 may set the output sizes of the first visual information and second visual information according to a preset condition.

In this case, the initial output sizes of the first visual information and second visual information are preset, and the second visual information may have a smaller output size than the first visual information since it serves as auxiliary information.

The preset condition may be at least one between a condition regarding the distance between a user and the display unit and a condition related to a user's touch pattern.

Meanwhile, the controller 180 may change the output size of the second visual information based on the distance between a sub-user and the display unit 151. More specifically, as shown in (a) of FIG. 8A, the controller 180 may output first visual in formation 610 for a primary user and second visual information 620 for a sub-user together on the display unit 151.

As shown in (a) and (b) of FIG. 8A, if the distance between a sub-user 420 and the display unit 151 is shortened, the output size of the second visual information may be increased. In this case, the controller 180 may decrease the output size of the first visual information by the same amount as the increase in the output size of the second visual information. To this end, the controller 180 may control the size of each region to correspond to the output size of the first visual information and the output size of the second visual information.

Meanwhile, as shown in (c) of FIG. 8A, if the sub-user 420 gets closer to the display unit 151 than the primary user 410, the controller 180 may reset the primary user 410 as a sub-user and the sub-user 420 as a primary user. In this case, the second visual information 620 may be outputted on the display unit 151 at a larger output size than the first visual information 610.

As such, in the present invention, information may be provided in an appropriate form if a sub-user is interested in this information. Also, if a primary user and a sub-user swap their positions each other, screen information may be naturally changed.

Alternatively, the controller 180 may set the output sizes of the first visual information and second visual information based on a user's touch pattern. The touch pattern may consist of at least one among the number of touch inputs, the order in which touch inputs are applied, and the properties of screen information displayed in a region where a touch input is applied.

For example, as shown in (a) and (b) of FIG. 8B, the primary user 410 applies a preset number of touch inputs or more (for example, two or more touch inputs) to the second visual information 620. In this case, as shown in (c) of FIG. 8B, the controller 180 may determine that the primary user 410 has the intention of using the second visual information 620, and output the second visual information at a larger output size than the first visual information. Through this, the present invention can limit the output of unnecessary information and provide necessary information effectively.

The above-described digital signage of the present invention is capable of providing visual information to a sub-user whom a primary user is with by dividing a display unit, while the primary user is using the digital signage. This way, the present invention allows for effectively providing relevant information to a sub-user whom a primary user is with, as well as to the primary user who is actively using the digital signage.

Furthermore, the present invention allows for effectively providing new information to a sub-user, while ensuring the usability of a primary user of the digital signage, by providing visual information related to the sub-user at an appropriate timing.

Furthermore, the present invention allows for delivering a new user experience by providing visual information related to a sub-user whom a primary user is with.

Meanwhile, digital signage may be installed near a transportation device such as a moving walkway that transports people. The moving walkway is a transportation device that people or objects can board, that can transport people or objects. Although the following description will be given of a digital signage installed near a moving walkway, digital signage may be installed near a vertical transportation device such as an elevator or escalator.

The digital signage installed near the transportation device may be installed along passenger passageways. To this end, the digital signage may extend in one direction like a long bar.

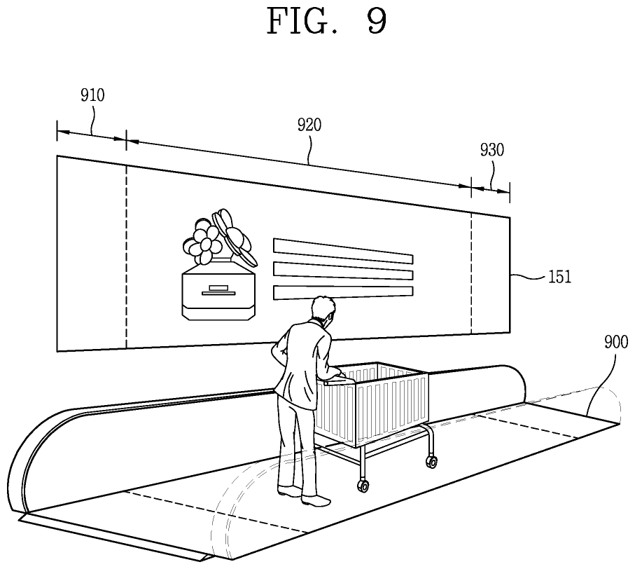

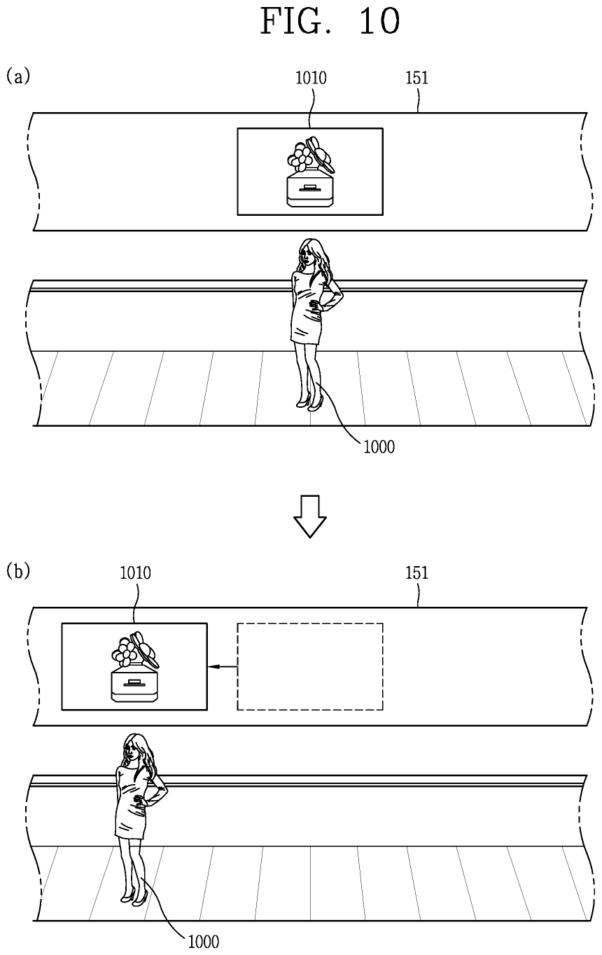

Below, FIG. 9 is a conceptual diagram showing how digital signage related to the present invention is installed near a transportation device. FIG. 10 is a conceptual diagram showing how visual information is displayed on a display unit of digital signage related to the present invention.

First of all, digital signage may be installed near a moving walkway. The digital signage may be installed taking into consideration the convenience of passengers on the moving walkway. For example, as shown in FIG. 9, the digital signage may be installed in a region where the eyes of the passengers on the moving walkway 900 go (for example, a wall, ceiling, etc. near the location where the moving walkway is installed). Also, the digital signage may be installed within the reach of passengers on the moving walkway 900 so that the passengers can apply a touch input to the display unit 151. Thus, the passengers on the moving walkway are able to see visual information outputted through the display unit of the digital signage and apply a touch input to the display unit, while on the moving walkway.

Moreover, the digital signage may extend and be installed along the pathway of the moving walkway. For example, as shown in FIG. 9, a moving walkway 900 moving in a straight line in one direction may extend and be installed in the same straight line as the moving walkway 900.

The digital signage may be installed at the same size as the installation size for the moving walkway. That is, the display unit 151 of the digital signage may be installed, from near a start point of the moving walkway to near an end point of the moving walkway.

The display unit 151 of the digital signage may be divided into a plurality of regions depending on the installation location. For example, referring to FIG. 9, the display unit 151 may comprise a start region 910 installed near the start point of the moving walkway 900, an end region 930 installed near the end point of the moving walkway 900, and a middle region between the start region 910 and the end region 930.

The digital signage may be set to display only limited visual information for the safety of passengers. In this regard, the digital signage may provide customized visual information for passengers in the middle region.

Through this, the digital signage according to the present invention may naturally expose passengers on a transportation device to visual information so that they can move from place to place.

Meanwhile, the digital signage according to the present invention may provide customized visual information to passengers. In this case, the controller 180 of the digital signage may control the display unit 151 so that the visual information displayed on the display unit 151 moves in sync with the passenger's moving speed. For example, as shown in (a) of FIG. 10, the controller 180 of the digital signage may display customized visual information 1010 in a region adjacent to a passenger 1000's location. Also, as shown in (b) of FIG. 10, if the passenger's location is shifted, the controller 180 may change the output position of the customized visual information 1010 in accordance with the passenger's moving speed so that the customized visual information 1010 is displayed in a region adjacent to the passenger's location.

Here, the customized visual information 1010 may be information related to the passenger. For example, the customized visual information 1010 may be specified timing information which is retrieved from a plurality of timing information pre-stored in the memory 179 based on information on the passenger's sex, age, clothing, and accessories. As such, the present invention allows the passenger to be naturally exposed to relevant timing information in a region where the passenger's eyes go.

The foregoing description has been given of a method of outputting visual information by digital signage installed in the vicinity of a transportation device.

Below is a description of a method of providing customized visual information to a plurality of users of digital signage installed in the vicinity of a transportation device.

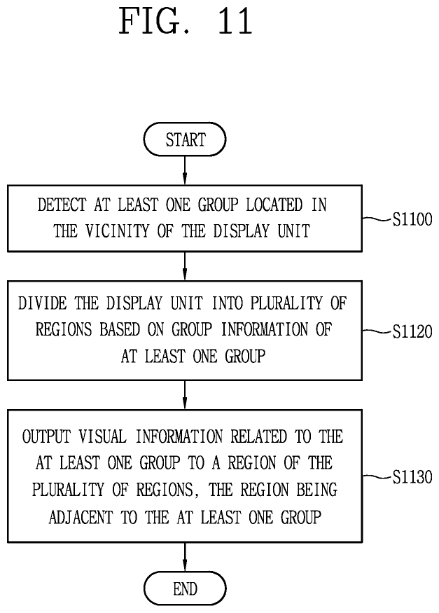

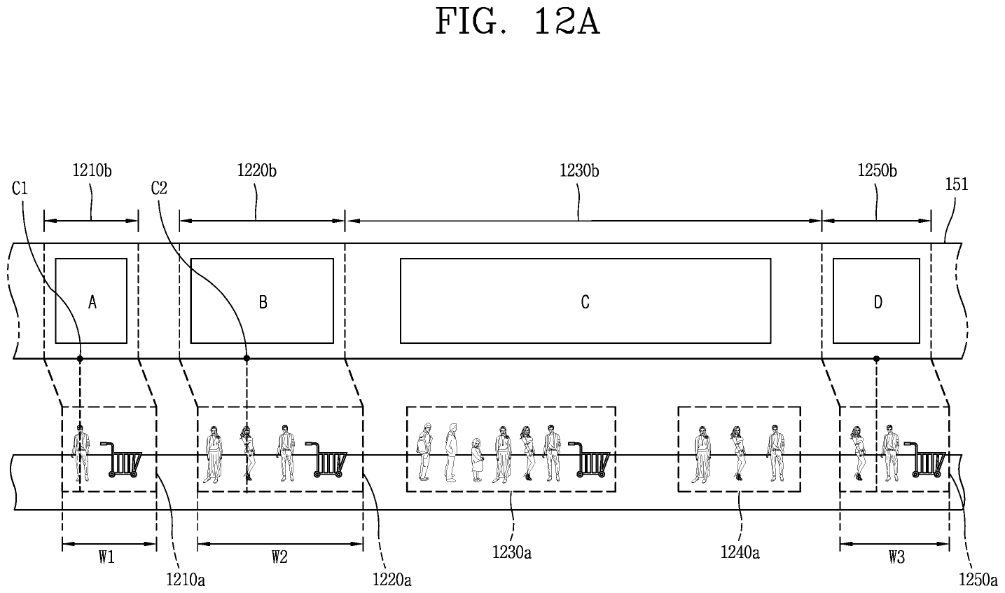

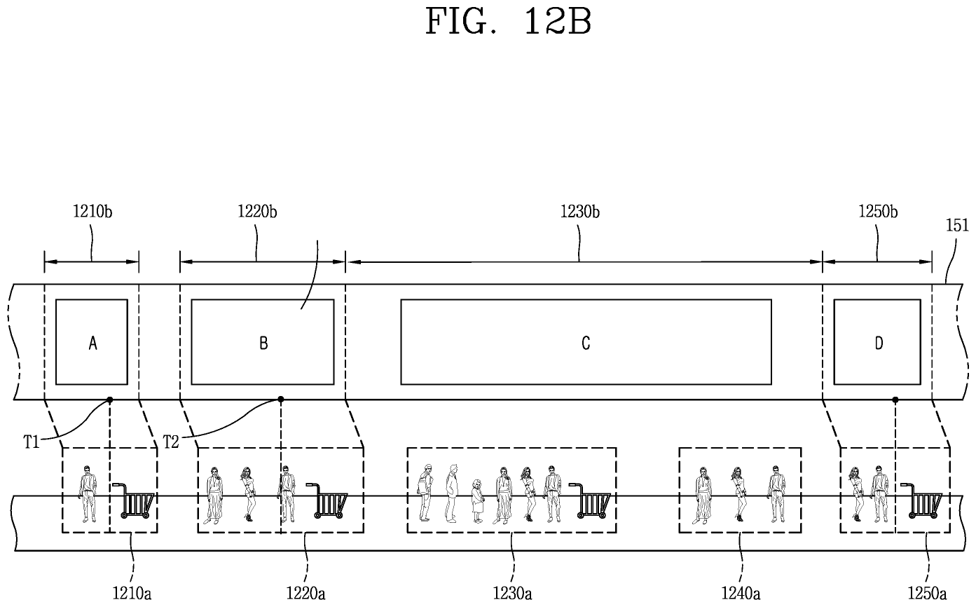

FIG. 11 is a flowchart explaining a method of allocating the display unit by group in digital signage related to the present invention. FIGS. 12A and 12B are conceptual diagrams for explaining the control method of FIG. 11 in digital signage related to the present invention.

First of all, referring to FIG. 11, the controller 180 of the digital signage according to the present invention may detect at least one group located in the vicinity of the display unit 151 (S1100).

The digital signage 100 according to the present invention may comprise a sensing unit 140 for detecting information related to the ambient environment of the digital signage 100.

The sensing unit 140 may detect at least one group located in the vicinity of the display unit 151. To this end, the sensing unit 140 may be a camera 121 for capturing an image of the vicinity of the display unit 151.

For example, the controller 180 may capture an image of the vicinity of the display unit 151 through the camera 121. Then, the controller 180 may analyze the captured image based on a preset image analysis algorithm and detect at least one group based on analysis results.

The controller 180 may distinguish between groups and non-groups according to image analysis results.

Here, a group may consist of one or more group members and transportation bodies. The group members are people who are provided with customized visual information, among all the people on the moving walkway. Such group members may be people who are to perform activities related to the place where the digital signage is installed.

The group members may be people who do not move on the moving walkway by their own efforts. As such, the controller 180 may view people moving at the same speed as the moving walkway as group members, but view people moving at a different speed from the moving walkway (for example, at a higher speed than the moving walkway) as non-group members. The controller 180 may determine that people viewed as non-group members are passers-by who are not a target of visual information. The moving speed of the moving walkway may be explained as a reference speed for determining who are group-members and who are not.

The controller 180 may detect the distance between group members in order to classify a plurality of persons in groups. If the distance between group members is a reference distance or shorter, the controller 180 may consider them as members of one group. The reference distance refers to a preset distance between people who are considered as being in the same party. Such a distance may be preset by a test.

For example, referring to FIG. 12A, three group members 1220a are at a reference distance or shorter from one another, the controller 180 may consider the three group members 1220a as being in the same group. Also, if a group member 1210a is located farther than a particular distance from the three group members 1220a, the controller 180 may consider him or her as being in another group.

Meanwhile, the group may consist of a predetermined number of group members or less. For example, the group may consist of three or four group members or less. As such, as shown in FIG. 12A, if more than the predetermined number of group members 1230a are located at a particular distance from one another, the controller 180 may not view them as a group. In this case, the controller 180 may view these group members as a non-group.

In contrast, if a preset number of people or less are present in a reference space, the controller 180 may view them as a group. Here, the reference space may have a preset area. For example, if a preset number of people or less are present in a reference space having a preset area, the controller 180 may view them as a group, or if more than the preset number of people are present in the reference space, the controller 180 may view them as a non-group.

Meanwhile, the controller 180 may distinguish between groups and non-groups, depending on whether a transportation body is present within a predetermined range from a space consisting of the preset number of group members or less. The transportation body may be a moving means with a handle to allow a user to transport their items—for example, a cart, baggage, a shopping basket, a box, etc. These transportation bodies may have wheels to make transportation easy.

That is, even if a predetermined number of people or less are present in a predetermined space, the controller 180 may distinguish between groups and non-groups again depending on the presence of a transportation body.

For example, as shown in FIG. 12A, if there is a cart within a predetermined range from a space consisting of three people, the controller 180 may view them as a group 1220a. On the contrary, if there is no transportation body within a predetermined range from a space consisting of three group members, the controller 180 may view them as a non-group. That is, the controller 180 may see a transportation body as an essential element of a group.

Meanwhile, the present invention allows for distinguishing between groups and non-groups depending on the presence of a transportation body, but is not limited thereto. Accordingly, in the present invention, group members may be viewed as a group as long as their number is equal to or less than a predetermined number.

Upon detecting at least one group, the controller 180 may divide the display unit 151 into a plurality of regions based on group information of the at least one group (S1120).

The controller 180 may retrieve group information of the at least one group. The group information may include width information of a group space occupied by a group, positional information of the group, group member information of the group, items information, etc.

The group space is a space where the group members and transportation body included in each group are located. The size of such a group space may be determined with respect to a group member and transportation body on the outermost edge. In this case, the width information of a group space may be the width of a cross-section of a space consisting of group members. For example, as shown in FIG. 12A, the width of a first group 1210a may be the width W1 of a cross-section of a space consisting of one group member and one transportation body. Likewise, a second group 1220a may have a width W2, and a third group 1250a may have a width W3. Such a width may be detected through image analysis of captured images of the group.

The positional information of the group may be positional information of the group on a moving walkway. The positional information also may be detected through image analysis of captured images of the group.

The group member information may include the group members' age group(s), the group members' average age, the group members' sex(es), etc. Moreover, the group member information may include information about relationships among the group members—for example, information about family, friends, and coworkers. Such group member information may be detected through image analysis of captured images of the group. The method of detection through image analysis is a conventional technology, so a detailed description thereof will be omitted in this specification.

The items information may include information about the types of items, the number of items, etc. For example, information about the items in the cart may include information about the types of items such as foods, electronics, bathroom items, and kitchen items. Also, the information about the items in the cart may further include information about the manufacturers and brands of the items.

Such items information may include information about the items in the transportation body and information about the items stored in a particular server. The information about the items in the transportation body may be detected through image analysis of captured images of the transportation body or based on barcode information of the items. The barcode information may be acquired when the barcode of each item is scanned by a barcode reader installed within the transportation body. That is, the controller 180 may acquire the barcode information of the items via communication with the barcode reader.

Moreover, the particular server is a server related to the place where the digital signage is installed—for example, a server provided by a supermarket or an airport server provided by an airport. A user may connect to these types of servers through their own log-in information, and may store information about items they want in a server after connecting to the server.

In this case, upon detecting identification information of the group members, the digital signage may retrieve items information related to the identification information from a server. The identification information of the group members is information that allows for identifying the group members, such as face recognition information, iris recognition information, and fingerprint information, which may be the same information as information for logging in to a particular server.

Such identification information may be entered into the digital signage by a group member. For example, if the handle portion of a cart has a fingerprint sensor and a group member holds the handle of the cart, the fingerprint sensor may retrieve fingerprint information from fingers touching the handle. Then, the fingerprint sensor may send this information to the controller 180 of the digital signage. Thus, the digital signage is capable of acquiring fingerprint information.

The controller 180 may divide the middle region 920 (see FIG. 9) of the display unit 151 into a plurality of sub-regions based on the width information of each of the at least one group. That is, the controller 180 may set the other region than the start region 910 and end region 920 of the display unit 151 as a region capable of displaying customized visual information.

The controller 180 may divide the display unit 151 into a plurality of regions so that a particular region of the display unit 151 is allocated to each of the at least one group. Here, the region allocation refers to the controller 180's act of setting a predetermined region only displaying group information related to each group, among all output regions of the display unit 151. That is, the controller 180 may divide the display unit 151 into a plurality of regions in order to set a predetermined region.

For example, as shown in FIG. 12A, upon detecting three groups, the controller 180 may divide the display unit so that a first region 1210b, second region 1220b, and third region 1250b of a predetermined size are formed near each group.

Moreover, the controller 180 may set the width of a region allocated to each group based on the width information of a group space for each group. For example, as shown in FIG. 12A, the controller 180 may set the width of the first region 1210b allocated to the first group 1210a to be equal to the width W1 of a group space for the first group 1210a. Likewise, the controller 180 may set the width of the second region 1220b allocated to the second group 1220a to be equal to the width W2 of a group space for the second group 1220a and set the width of the third region 1250b allocated to the third group 1250a to be equal to the width W3 of a group space for the third group 1250a.

Moreover, the controller 180 may divide the display unit in such a way that the center of a group coincides with the center of the region allocated to that group. The center of a group may be set as the center for the group members of that group, without taking the transportation body in the group into consideration. For example, as shown in FIG. 12A, the controller 180 may set the group center of the first group 1210a as c1, the group center of the second group 1220a as c2, and the group center of the third group 1250a as c3.

Accordingly, in the present invention, the respective regions can be arranged within the reach of the group members. Moreover, the present invention allows the group members to perform control related to visual information without reaching out their hands to a region where the transportation body is located, by limiting the displaying of visual information in the region where the transportation body is located and providing visual information based on the group members' locations.

Meanwhile, the digital signage may not be able to receive touch inputs. In this case, the digital signage may move the center of the region allocated to each group to a location that is comfortable for the group members to see visual information. In this case, the center of the group may be set as the center of the group space in which the transportation body and the group members are included.

As shown in FIG. 12B, the digital signage allows the center of the group space for each group and the center of the region allocated to each group to coincide with each other. That is, the center T1 of the group space for the first group 1210a can coincide with the center of the first region 1210b, the center T2 of the group space for the second group 1220a can coincide with the center of the second region 1220b, and the center T3 of the group space for the third group 1250a can coincide with the center of the third region 1250b. Thus, the present invention has the effect of naturally exposing the group members to visual information by locating the center of the visual information where the group members' eyes go.

After allocating different regions respectively to the at least one group, if the location of the at least one group is changed by the moving walkway, the controller 180 may also change the output positions of the different regions allocated respectively to the at least one group. That is, the controller 180 may control the display unit 151 in such a manner that the region allocated to each group is located where the location of at least one group is changed. This process has been described with reference to FIG. 10, so a detailed description thereof will be omitted.

After the display unit 151 is divided into a plurality of regions, the controller 180 may output visual information related to the at least one group to a region of the plurality of regions, the region being adjacent to the at least one group (S1130).

After allocating a region to each of the at least one group, the controller 180 may output visual information related to each group to the region allocated to each group.

For example, the controller 180 may output visual information A related to the first group 1210a on the first region 1210b allocated to the first group 1210a. Likewise, the controller 180 may output visual information B related to the second group 1220a on the second region 1220b allocated to the second group 1210b, and output visual information C related to the third group 1250a on the third region 1250b allocated to the third group 1250a.

The visual information related to the groups may be information that is retrieved based on the group information, among the plurality of information stored in the memory 170. The memory 170 may pre-store a plurality of visual information that can be outputted on the display unit of the digital signage. Alternatively, the plurality of visual information is visual information that is stored in an external server. The controller 180 may receive the plurality of visual information via communication with the external server.

The plurality of visual information may be advertising information.

In an example, if a group member included in the first group 1210a is deemed to be a man in his 30's, the controller 180 may output razor advertising information A on the first region 1210b. In another example, if the relationship between the group members included in the second group 1220a is deemed to be a family, the controller 180 may output advertising information B about a family travel package on the second region 1220b. In yet another example, if the transportation body included in the third group 1230a contains party goods, the controller 180 may output advertising information C about a party planner on the third region 1250b.

Moreover, the visual information may be direction information related to the place where the digital signage. The direction information may be route information from the location of the advertisement being displayed to a destination.

For example, if the transportation body included in the third group 1230a contains party goods, the controller 180 may output, on the third region 1250b, route information from the location of the digital signage currently outputting the advertisement to a place where the advertised item is present. Thus, the present invention allows a user to easily locate an item of interest in a huge place like the one where the digital signage is installed.

Meanwhile, the controller 180 may determine whether to output preset visual information to an empty region between regions allocated to groups. The preset visual information is visual information stored in the memory 170, which may be set in advance by a user to be outputted to the empty region. Moreover, the preset visual information may be visual information that is not related to the group information. For example, the preset visual information may be advertising information about the place where the digital signage is installed. Alternatively, the preset visual information may be advertising information about the manufacturer of the digital signage.

If the area of the empty region is a reference area or larger, the controller 180 may output the preset visual information on the empty region. On the contrary, if the area of the empty region is smaller than the reference area, the controller 180 may not output the preset visual information on the empty region. Here, the reference area is a preset area, which may be the output size of the preset visual information.

For example, as shown in FIG. 12A, if the second region 1220b and the third region 1250b are allocated respectively to the second group 1220a and the third group 1250a, an empty region 1230b may be created between the second group 1220b and the third region 1250b. In this case, if the area of the empty region 1230b is a reference area or larger, the controller 180 may output preset visual information C.

Thus, the present invention may provide customized visual information to at least one group located near the digital signage, and at the same time, provide preset visual information even to a region where the customized visual information for at least one group is not outputted. Through this, users who do not belong to any group may be exposed to relevant visual information.

The foregoing description has been given of a method in which, if there are a plurality of target groups of visual information, customized visual information is provided to each of the plurality of groups. Through this, the present invention may provide customized information to a plurality of groups in a proper output form.

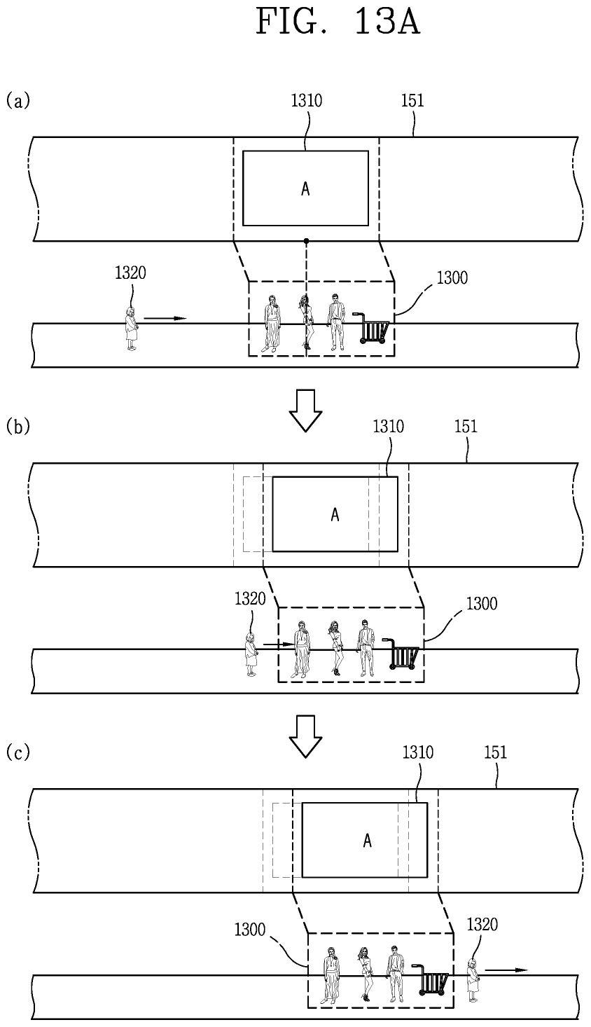

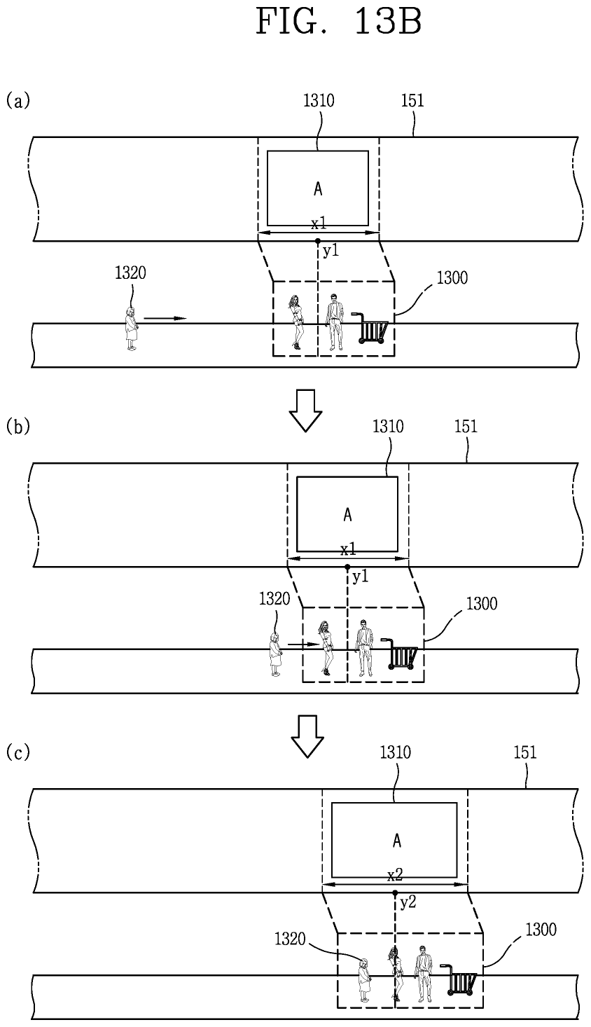

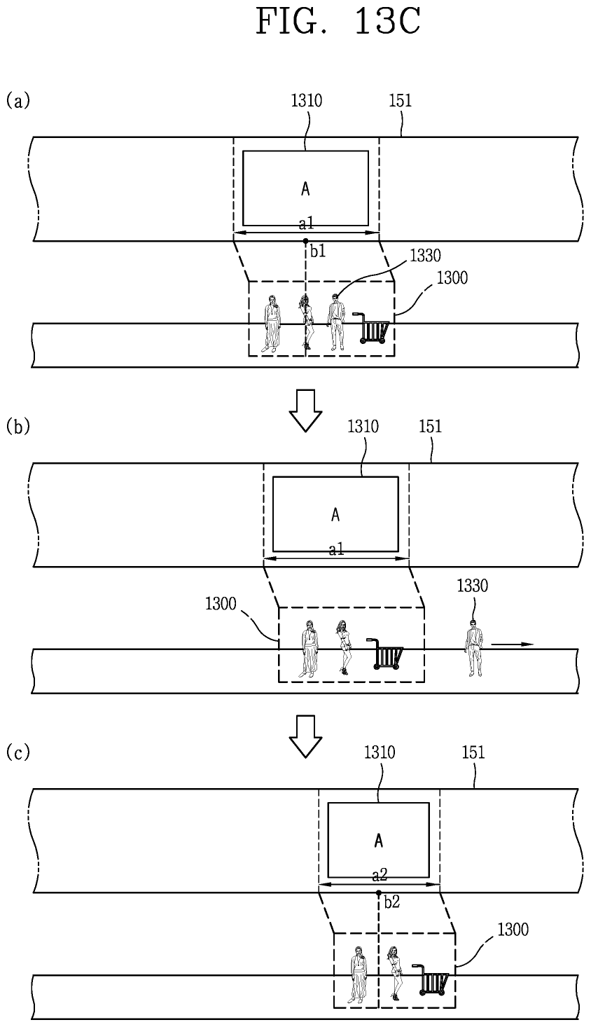

Below is a description of an embodiment in which, if the number of group members of a particular group is changed after a region is allocated to the particular group, the size and location of the region allocated to the particular group are changed. FIGS. 13A to 13C are conceptual diagrams showing an embodiment in which, if the number of group members of a particular group is changed, the size and location of a region allocated to the particular group are changed.

Upon detecting at least one group in the vicinity of the display unit 151, the controller 180 may allocate output regions of the display unit 151 respectively to the at least one group. Also, the controller 180 may provide customized visual information for each group to the region allocated to each group.

Meanwhile, the controller 180 may detect a change to the group members of a particular group, while customized visual information for the particular group is being displayed in a particular region. More specifically, the controller 180 may capture images of the vicinity of the display unit 151 at preset intervals or in real time and determine whether the number of group members in each of the at least one group has changed or not.

In this instance, as shown in (a) of FIG. 13A, the controller 180 may allocate a particular region 1310 to a particular group 1300, and display visual information A related to the particular group 1300 in the particular region 1310. Moreover, as shown in (b) of FIG. 13A, the controller 180 may move the particular region 1310 in sync with the moving speed of the particular group 1300.

Meanwhile, referring to (a) of FIG. 13A, the controller 180 may detect a new group member 1320 getting closer to the location of the particular group 1300 through the camera 121.

In this case, the controller 180 may determine whether the new group member 1320 belongs to the particular group 1300 or not. More specifically, the controller 180 may determine whether the new group member 1320 is staying at a specific distance or shorter from some group members of the particular group 1300 for a preset amount of time.

As shown in (C) of FIG. 13A, if the new group member 1320 moves to a location more than the specific distance away from the group members of the particular group 1300 within a preset time, the controller 180 may determine that the new group member 1320 does not belong to the particular group 1300. Thus, the controller 180 may not change the location or size of the particular region 1310 allocated to the particular group 1300.

Contrariwise, referring to (a) and (b) of FIG. 13B, the new group member 1320 may be at a specific distance away from some group members of the particular group 1300 for more than a preset amount of time. In this case, the controller 180 may consider the new group member 1320 as belonging to the particular group 1300.

If the new group member 1320 is considered as belonging to the particular group 1300, the controller 180 may change the location and size of the particular region 1310 allocated to the particular group 1300.

For example, as shown in (c) of FIG. 13B, if the new group member 1320 is added, the width of a group space occupied by the particular group 1300 may be lengthened (x1->x2). Thus, the controller 180 may change the width of the particular region 1310 allocated to the group 1300 from x1 to x2. Moreover, when the group center of the particular group 1300 is changed from y1 to y2 by the addition of the new group member 1320, the controller 180 may change the center of the particular group 1310 from y1 to y2.

Also, the controller 180 may detect some of the group members in the particular group being excluded from the particular group through the sensing unit. That is, the controller 180 may detect a reduction in the number of groups members in the particular group. Referring to (a) of FIG. 13C, the controller 180 may detect the movement of a particular group member 1330 among the group members of the particular group 1300 through the sensing unit. Moreover, as shown in (b) of FIG. 13, upon detecting the particular group member 1330 being at a particular distance away from the other group members of the particular group 1300, the controller 180 may exclude the particular group member 1330 from the particular group 1300.

In this case, the controller 180 may change the location and size of the particular region 1310 allocated to the particular group 1300.

Referring to (c) of FIG. 13C, if the particular group member 1330 is excluded from the particular group 1300, the width of the particular group 1300 may be changed from a1 to a2. Based on the change in the width of the particular group 1300, the controller 180 may change the width of the particular region 1310 allocated to the particular group 13400 from a1 to a2. Also, if the group center of the particular group 1300 is changed from b1 to b2, the controller 180 may change the center of the particular group 1310 allocated to the particular group 1300 from b1 to b2.

Meanwhile, although not shown, if group information is changed by the addition or exclusion of a group member to or from a particular group, the controller 180 may change visual information related to the particular group displayed in a particular region too. Thus, the present invention may provide the currently most relevant visual information for a group in real time.

The foregoing description has been given of a method of changing the size and location of a particular region allocated to a particular group by the addition or exclusion of a group member. Through this, the present invention allows for changing the size and location of a region allocated to a group in real time, in response to changes in the properties of the group.

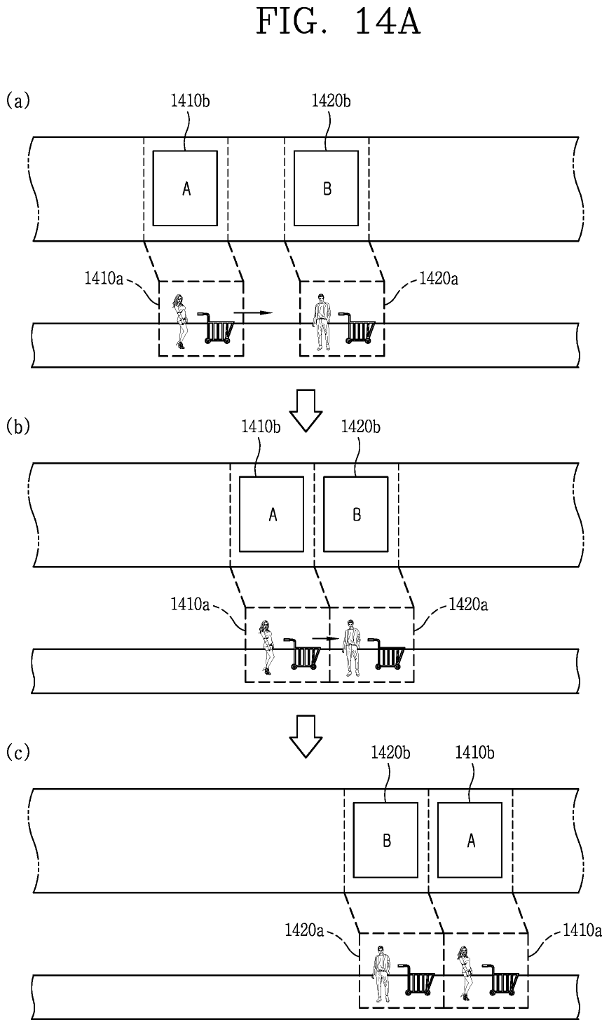

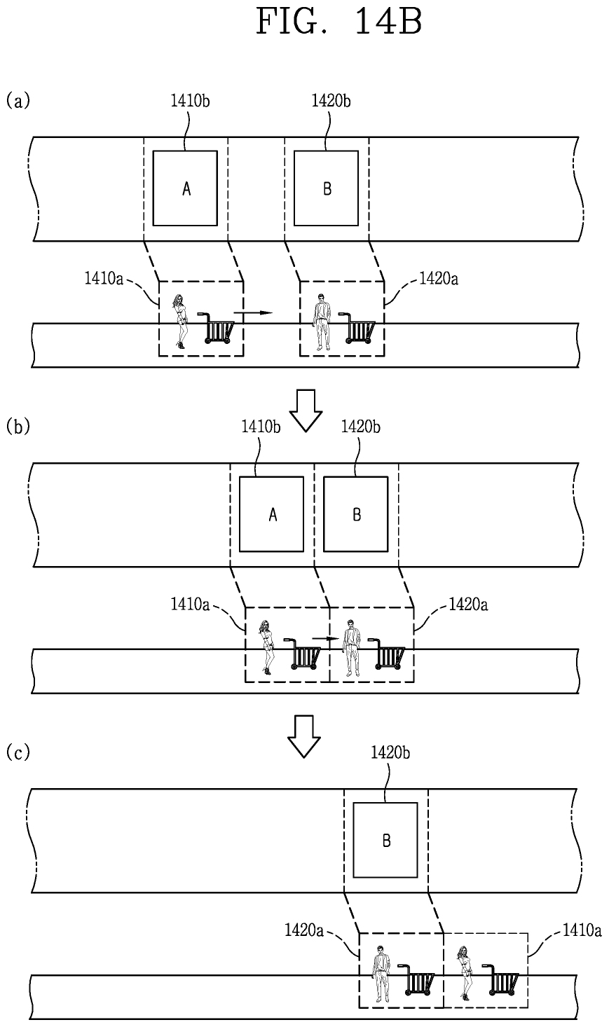

Below is a description of a method of allocating a region for each group if the locations of two groups are changed when different regions are respectively allocated to different groups. FIGS. 14A and 14B are conceptual diagrams showing how a region is allocated for each group if the locations of two groups are changed when different regions are respectively allocated to different groups.

The digital signage according to the present invention may allocate output regions of the display unit 151 to at least one group located in the vicinity of the display unit 151. For example, as shown in (a) of FIG. 14A, the controller 180 may allocate a first region 1410b and a second region 1420b to a first group 1410a and second group 1420a located in an adjacent region, respectively.

The controller 180 may detect the first group 1410a moving toward the second group 1420a. As shown in (b) of FIG. 14A, once the first group 1410a has moved toward the second group 1420a, the first region 1410b allocated to the first group 1410a may move toward the second region 1420b as well.

If different regions allocated to different groups at least partially overlap, the controller 180 may limit the output of visual information displayed in a region moving faster than a reference speed, among all the different regions. Here, the reference speed may be the moving speed of the moving walkway. For example, if the first group 1410b allocated to the first group 1410a overlaps the second region 1420b by the movement of the first group 1410a toward the second group 1420a, the controller 180 may not output visual information A related to the first group 1410a displayed on the first region 1410b any longer. Through this, the present invention may keep visual information displayed in two regions from overlapping each other.

Meanwhile, if the first region 1410b overlaps the second region 1420b and then the first region 1410b and the second region 1420b are separated from each other, the controller 180 may output the visual information A related to the first group 1410a over again on the first region 1410a. As shown in (c) of FIG. 14A, if the first group 1410a has moved a predetermined distance from the second group 1410b, the first region 1410b may be re-allocated to the first group 1410a. The predetermined distance is a distance sufficient to keep the group spaces of these groups from overlapping each other.

If the moving speed of the first group 1410a is a preset speed or higher, the controller 180 may deallocate the first region 1410b from the group 1410a. Here, the preset speed is a speed preset by the user, at which the first group is assumed to not see visual information. Moreover, the deallocation is an act of deleting settings information for allocating a region to the first group 1410a from the memory 170 and keeping visual information related to the first group 1410a from being displayed. That is, if there is no need to provide visual information to the first group any longer, the controller 180 may deallocate the first region 1410b.

For example, as shown in (a) to (c) of FIG. 14B, if the moving speed of the first group 1410a is a preset speed or higher, the controller 180 may deallocate the first region 1410b. Thus, the controller 180 may not display visual information related to the first group 1410a any longer.

The foregoing description has been given of a control method, in which, when different regions are allocated to different groups, the allocated regions overlap due to movements of the groups. Through this, the present invention may reduce the complexity of visual information and display the visual information in an appropriate form, when different regions allocated to different groups overlap.

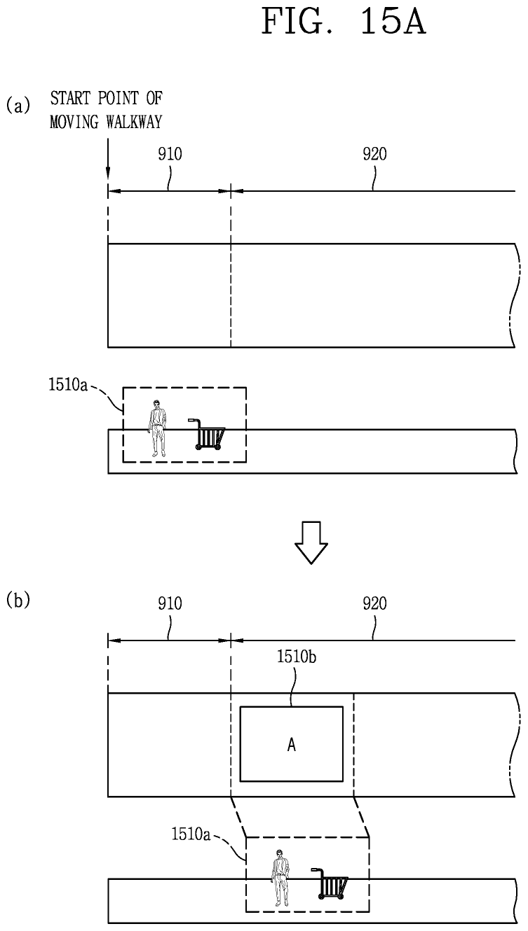

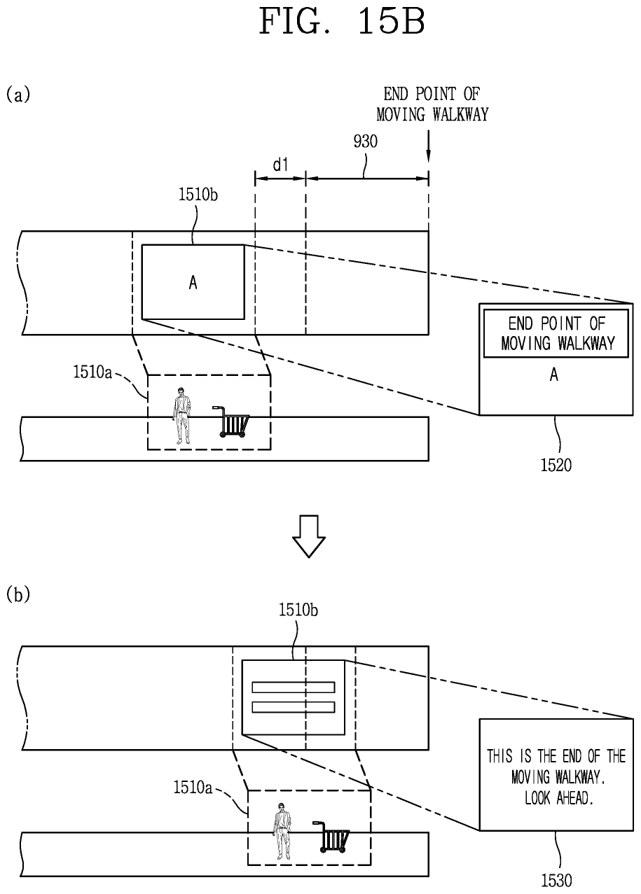

Below is a description of a control method for digital signage installed near the start point and the end point of a moving walkway. FIGS. 15A and 15B are conceptual diagrams showing a control method digital signage installed near the start point and the end point of a moving walkway.

In the digital signage according to the present invention, the display unit may be installed, from the start point of the moving walkway to the end point of the moving walkway.

The display unit 151 may comprise a start region 910 (see FIG. 9) installed near the start point, an end region 930 (see FIG. 9) installed near the end point, and a middle region 920 between the start region 910 and the end region 930. As discussed previously, the middle region 920 displays visual information related to a group.

Meanwhile, the controller 180 may limit the output of visual information in the start region 910 and end region 930 for safety reasons. Specifically, the controller 180 may set the start region 910 to output a preset image only or to not output visual information.

Moreover, the controller 180 may detect group information of at least one group present near the start region 910. That is, the controller 180 may detect group information about groups on the moving walkway from near the start region 910.

In addition, if a group detected in the start region 910 moves to the middle region 920, the controller 180 may allocate a particular region of the display unit 151 based on the group information. For example, as shown in (a) and (b) of FIG. 15A, the controller 180 may detect a particular group 1510a and group information of the particular group 1510a in the start region 910. Afterwards, the controller 180 may allocate a particular region 1510b to the particular group 1510a and output visual information A related to the particular group 1510a on the particular region 1510b.

Further, although not shown, if the moving speed of a group member is a preset speed or higher in the start region 910, the controller 180 may consider this group member as a non-group member and may not detect group information.

Meanwhile, as shown in (a) of FIG. 15B, if the distance between the particular region 1510b and the end region 930 is a predetermined distance d1 or less, when the particular region 1510b is allocated to the particular group 1510a, the controller 180 may output notification information 1520 indicating that the end region 930 is reached.

Moreover, as shown in (b) of FIG. 15B, if the particular region 1510b and the end region 930 at least partially overlap, the controller 180 may finish outputting the visual information related to the particular group 1510a.

Meanwhile, visual information 1530 indicating that the moving walkway has ended may be outputted to the end region 930. Such visual information may be video, text, characters, image, etc. Accordingly, the present invention can ensure the safety of users by indicating to the users the end point of the moving walkway.

The foregoing description has been given of a control method for output regions of the display unit installed near the start point and the end point of the digital signage according to the present invention.

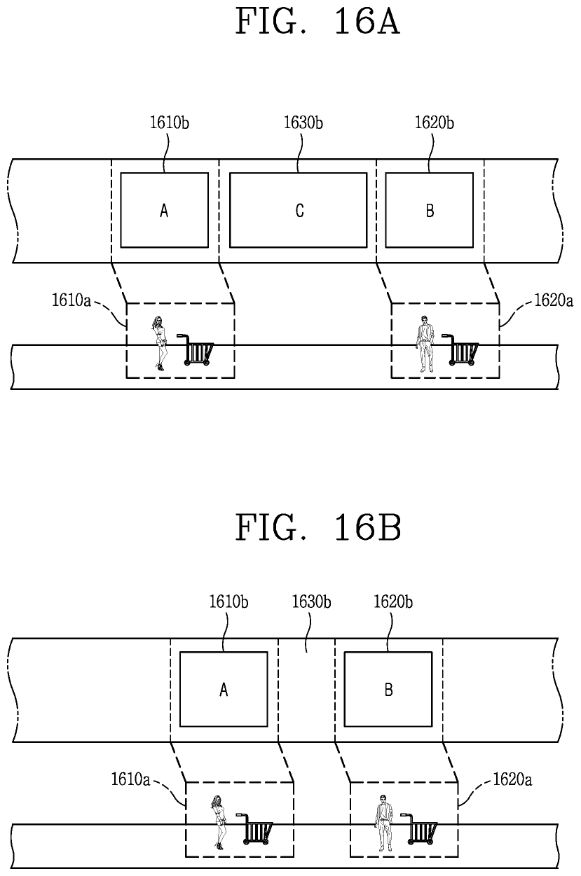

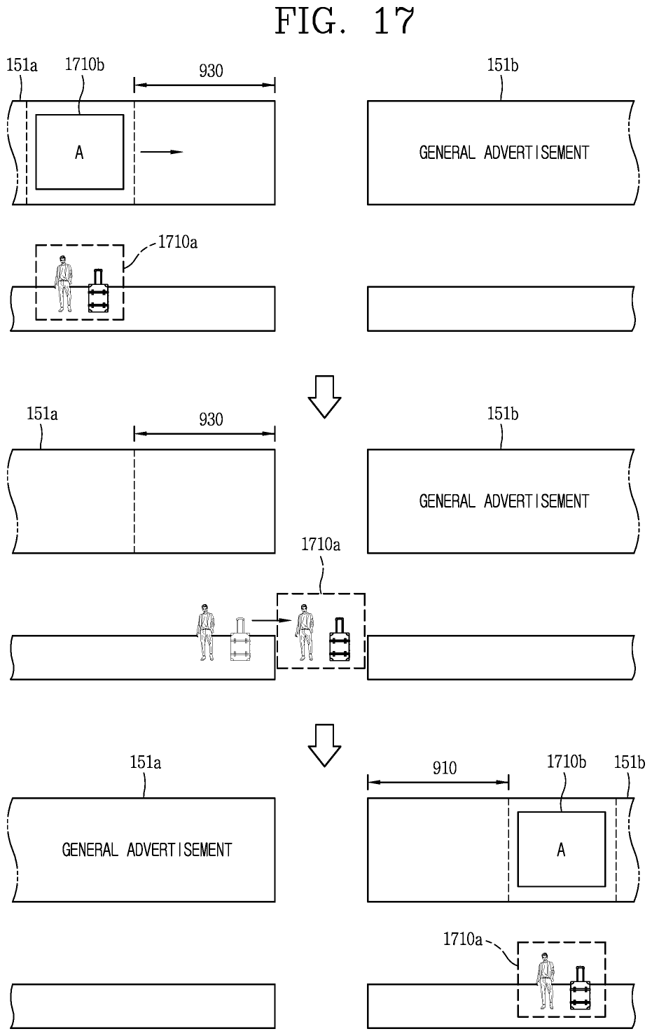

Below is a description of a method of outputting preset visual information in an output region of the display unit 151 not allocated to a particular group. FIGS. 16A and 16B are conceptual diagrams showing a method of outputting preset visual information in an output region of the display unit 151 not allocated to a particular group.

The display unit 151 of the digital signage 100 according to the present invention may further comprise an empty region between regions allocated to at least one group. For example, referring to FIG. 16A, the display unit 151 may have a third region 1630b between a first region 1610b allocated to a first group 1610a and a second region 1620b allocated to a second group 1620a.

The controller 180 may determine whether to output preset visual information or not, based on the area of the third region 1630b. The preset visual information is basically information that is set to be outputted—for example, a public relations image of the place where the digital signage is installed.

As shown in FIG. 16A, if the area of the third region 1630b is a reference area or larger, the controller 180 may output preset visual information C. On the contrary, as shown in 16B, if the area of the third region 1630b is smaller than the reference size, the controller 180 may not output the preset visual information. In this case, the controller 180 may leave the third region 1630b as an empty region where no visual information is outputted or output an image that is set as a background image. Here, the reference area may be the output size of the preset visual information.

The foregoing description has been given of a method of making use of an empty region which is not allocated to a particular group.

Below is a description of a method of delivering visual information provided through digital signage to an external device. FIG. 17 shows conceptual diagrams of a method of delivering visual information provided through digital signage to an external device.

Hereinafter, the ordinal numbers “first” and “second” will be used to distinguish a plurality of digital signs, and the components of each digital sign will be labeled by alphabets.

The digital signage according to the present invention may be installed along the pathway of a moving walkway. Meanwhile, two or more moving walkways may be installed at a distance from each other in the same place. For example, two or more moving walkways may be installed between floors, or along one long corridor. According to the present invention, digital signage may be installed near each moving walkway.

Meanwhile, if a user moves between two moving walkways, they may be provided with visual information through respective display units installed near the moving walkways. For example, as shown in (a) of FIG. 17, a particular group may be provided with particular information A through a first display unit 151a.

In this case, as shown in (b) of FIG. 17, while the particular information A is being displayed on the first display unit 151a of the first digital signage, the controller 180 may detect a particular group 1710a moving from the moving walkway where the first digital signage is installed to the moving walkway where the second digital signage is installed.

Specifically, the controller 180 may detect the presence of the particular group 1710a in the end region of the first display unit 151a and then detect the particular group 1710a again in the start region of a second display unit 151b of the second digital signage.

Hereupon, as shown in (c) of FIG. 17, the second controller 180b of the second digital signage may receive particular information A from the first controller 180a of the first digital signage. Also, the second controller 180b may output particular information A in the middle region of the second display unit 180b.

Once the particular information A is outputted on the second display unit 151b, the second controller 180b may limit the outputting of the previously outputted visual information. Similarly, when the outputting of the particular information A is finished, the first controller 180 may output basic information (e.g., advertising information).

The digital signage according to the present invention discussed above provides customized information for each of a plurality of groups and ensures the usability of each individual group, by dividing a display unit into a plurality of regions according to the locations of groups present in the vicinity of the display unit, allocating a region of the plurality of regions, the region being adjacent to the groups to the groups, and providing information related to the groups.

Furthermore, the present invention allows for providing more convenient usability to every group member using group information by setting the areas of different regions allocated to different groups based on each group's group information.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. An image output device comprising:
an image output unit;
a sensor configured to detect at least one group including one or more group members located in a vicinity of the image output unit; and
a controller configured to:
divide the image output unit into a plurality of regions for allocation to the at least one group, the plurality of regions including a region adjacent to the at least one group having a width corresponding to a width of a space occupied by the at least one group, and
output, via the image output unit, visual information to the region among the plurality of regions that is adjacent to the at least one group, the visual information being related to the at least one group.

2. The image output device of claim 1, wherein the at least one group further includes a transportation body, and
wherein the space occupied by the at least one group is determined based on a group member and a transportation body that are both included in the at least one group and located on an outermost edge of the at least one group.

3. The image output device of claim 1, wherein the controller is further configured to:
divide the image output unit into the plurality of regions with a center of the region adjacent to the at least one group coinciding with a center of a group member among the one or more group members when the display image output unit is capable of receiving touch inputs, and
divide the image output unit into the plurality of regions with the center of the region adjacent to the at least one group coinciding with a center of the space occupied by the at least one group when the image output unit is not capable of receiving touch inputs.

4. The image output device of claim 1, wherein the controller is further configured to:
classify the one or more group members as a particular group when a distance between the one or more group members group members is less than or equal to a predetermined reference distance.

5. The image output device of claim 1, wherein the controller is further configured to:
classify the one or more group members as a particular group when a distance between the one or more group members is less than or equal to a predetermined reference distance and a number of the one or more group members is less than or equal to a predetermined group member number, and
classify the one or more group members as a non-group when the distance between the one or more group members is less than or equal to the predetermined reference distance and the number of the one or more group members is greater than the predetermined group member number.

6. The image output device of claim 1, wherein the controller is further configured to:
classify the one or more group members as a particular group when a moving speed of the one or more group members is less than or equal to a predetermined reference speed.

7. The image output device of claim 1, wherein the image output unit includes a start region and an end region located at opposite ends of the image output unit and a middle region between the start region and the end region, and
wherein the middle region is divided into a plurality of sub-regions based on group information of the at least one group.

8. The image output device of claim 7, wherein the controller is further configured to:
output notification information on the visual information related to the at least one group in an overlapping manner, the notification information indicating that at least one group member within the at least one group is adjacent to or approaching the end region of the image output unit.

9. The image output device of claim 7, wherein the controller is further configured to:
terminate the output of the visual information related to the at least one group when the region allocated to the at least one group at least partially overlaps the end region of the image output unit.

10. The image output device of claim 1, wherein the controller is further configured to:
divide the image output unit into the plurality of regions based on group information related to the at least one group,
wherein the group information related to the at least one group includes information about at least one group member included in the at least one group and information about items in a transportation body included in the at least one group.

11. The image output device of claim 1, wherein the controller is further configured to:
output preset information when an area of a region not adjacent to the at least one group, among the plurality of regions, is greater than or equal to a preset area, and
output a background image when the area of the region not adjacent to the at least one group is less than the preset area.

12. The image output device of claim 1, wherein the controller is further configured to:
adjust the width of the region adjacent to the at least one group, in response to detecting a change in a number of group members included in the at least one group.

13. The image output device of claim 1, wherein the at least one group includes a first group and a second group, and
wherein the controller is further configured to:
allocate a first region among the plurality of regions to the first group, and a second region among the plurality of regions to the second group, and
terminate outputting first visual information related to the first group on the first region or second visual information related to the second group on the second region, in response to the first region and the second region at least partially overlapping with each other.

14. The image output device of claim 13, wherein the controller is further configured to:
deallocate the first region from the first group when a speed of the first group is greater than or equal to a predetermined reference speed.

15. A method for controlling an image output device including an image output unit installed in a vicinity of a moving walkway configured to move in one direction, the method comprising:
detecting at least one group located in the vicinity of the image output unit;
dividing the image output unit into a plurality of regions for allocation to the at least one group, the plurality of regions including a region adjacent to the at least one group having a width corresponding to a width of a space occupied by the at least one group; and
outputting visual information to the region among the plurality of regions that is adjacent to the at least one group, the visual information being related to the at least one group.

16. The method of claim 15, wherein the at least one group includes one or more group members and a transportation body, and
wherein the space occupied by the at least one group is determined based on a group member and a transportation body that are both included in the at least one group and located on an outermost edge of the at least one group.

17. The method of claim 15, wherein a center of the region adjacent to the at least one group coincides with a center of a group member among the one or more group members when the image output unit is capable of receiving touch inputs.

18. The method of claim 15, wherein a center of the region adjacent to the at least one group coincides with a center of the space occupied by the at least one group when the image output unit is not capable of receiving touch inputs.

19. The method of claim 15, wherein the detecting the at least one group includes classifying the at least one group as a particular group when a distance between group members within the at least one group is less than or equal to a predetermined reference distance.

20. The method of claim 15, wherein the dividing the image output unit into the plurality of regions is based on group information related to the at least one group, and
wherein the group information related to the at least one group includes information about group members included in the at least one group and information about items in a transportation body included in the at least one group.

21. An image output device comprising:
an image output unit configured to output first visual information;
a camera configured to capture an image of a vicinity of the image output unit; and
a controller configured to:
in response to the captured image including a plurality of users, identify a primary user and a sub-user among the plurality of users based on a preset condition,
output, via the image output unit, first visual information for the primary user, and
output, via the image output unit, a graphic object for representing available second visual information for the sub-user based on user information of the sub-user, the second visual information being different than the first visual information.

22. The image output device of claim 21, wherein the controller distinguishes between users viewing the image output unit and users not viewing the image output unit, based on movement information of the plurality of users included in the captured image, and classifies the users viewing the image output unit into primary users and sub-users based on the preset condition.

23. The image output device of claim 21, wherein the preset condition includes a condition related to a user movement, a center of a user, a distance between the users, a user age group, or a user gender.

24. The image output device of claim 21, wherein the controller is further configured to:
identify a plurality of sub-users among the plurality of users,
determine one of the plurality of sub-users as a particular sub-user based on user information of the plurality of sub-users, and
output the second visual information to the particular sub-user.

25. The image output device of claim 21, wherein the user information includes at least one of a user gender, a user movement, a worn accessory or clothing item.

26. The image output device of claim 25, wherein the user movement includes an act of moving closer to the image output unit or an act of moving closer to the primary user.

27. The image output device of claim 21, wherein the controller is further configured to:
output, via the image output unit, the first visual information and the second visual information together when the graphic object is selected by one of the plurality of users.

28. The image output device of claim 27, wherein the controller is further configured to:
determine an output size of the first visual information based on a distance between the primary user and the image output unit, and
determine an output size of the second visual information based on a distance between the sub-user and the image output unit.

29. The image output device of claim 27, wherein the controller determines an output size of the first visual information or an output size of the second visual information based on a touch pattern of touch inputs applied to the image output unit.

30. The image output device of claim 21, wherein the controller is further configured to:
terminate output of the second visual information when a control command related to the second visual information has not been received for a preset period of time or the sub-user is not detected.
